(19) United States
(12) Patent Application Publication
(10) Pub. No.: US 2026/0178426 A1
(43) Pub. Date: Jun. 25, 2026

(54) APPARATUS, METHOD, AND COMPUTER PROGRAM PRODUCT FOR OUTPUTTING A PROGRAM SUBSIDIARY EXECUTION INCIDENT OUTPUT INTERFACE COMPONENT TO A PROGRAM ORCHESTRATION OPERATIONS EXECUTION INCIDENT INTERFACE

(71) Applicant: ATLASSIAN PTY LTD., Sydney (AU)

(72) Inventors: Makarand Milind GOMASHE, Nagpur (IN); Ugur TURAN, Ankara (TR)

(21) Appl. No.: 19/001,211

(22) Filed: Dec. 24, 2024

(51) Int. Cl. G06F 9/54; G06F 11/34

(52) U.S. Cl. CPC G06F 9/542; G06F 11/3495

(57) ABSTRACT

Apparatus, methods, and computer program products for outputting a program subsidiary execution incident output interface component for rendering to a program orchestration operations execution incident interface are provided herein. For example, a method may include identifying an operations execution incident event, causing using an automated program subsidiary execution incident engine, execution of a first program subsidiary execution incident responsive action, and outputting a program subsidiary execution incident output interface component for rendering to a program orchestration operations execution incident interface.

### BACKGROUND

Various methods, apparatuses, and systems provide tools to plan, collaborate, execute, address, resolve and monitor units, events, vectors, and interface components in program orchestration operations execution incident environments. Applicant has identified a number of deficiencies and problems associated with tools for effectively, reliably, and securely managing actions, features, representations, and interface components in program orchestration operations execution incident systems. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, computer program products, and/or the like that are configured for effectively and efficiently outputting, in a program orchestration operations execution incident system, one or more interface components, such as a program orchestration operations execution incident interface component.

In accordance with some exemplary embodiments of the present disclosure, an example apparatus for outputting a program subsidiary execution incident output interface component for rendering to a program orchestration operations execution incident interface is provided. In some embodiments, the apparatus may comprise at least one processor and at least one memory including program code. In some embodiments, the at least one memory and the program code are configured to, with the at least one processor, cause the apparatus to identify an operations execution incident event. In some embodiments, the at least one memory and the program code are configured to, with the at least one processor, cause the apparatus to access program operations execution incident data based on the operations execution incident event. In some embodiments, the program operations execution incident data is representative of a program execution incident action set. In some embodiments, the program execution incident action set comprises one or more program subsidiary execution incident responsive actions. In some embodiments, the at least one memory and the program code are configured to, with the at least one processor, cause the apparatus to generate a program orchestration operations execution incident interface component based on the operations execution incident event and program operations execution incident data. In some embodiments, the program orchestration operations execution incident interface component comprises a program execution incident action set representation. In some embodiments, the at least one memory and the program code are configured to, with the at least one processor, cause the apparatus to output the program orchestration operations execution incident interface component for rendering to a program orchestration operations execution incident interface. In some embodiments, the at least one memory and the program code are configured to, with the at least one processor, cause the apparatus to cause, using an automated program subsidiary execution incident engine, execution of a first program subsidiary execution incident responsive action of the one or more program subsidiary execution incident responsive actions. In some embodiments, the at least one memory and the program code are configured to, with the at least one processor, cause the apparatus to generate a program subsidiary execution incident output interface component. In some embodiments, the program subsidiary execution incident output interface component comprises a program subsidiary execution incident output representation associated with the first program subsidiary execution incident responsive action. In some embodiments, the program subsidiary execution incident output representation is indicative of a program subsidiary execution incident output. In some embodiments, the at least one memory and the program code are configured to, with the at least one processor, cause the apparatus to output the program subsidiary execution incident output interface component for rendering to the program orchestration operations execution incident interface.

In some embodiments, the at least one memory and the program code are configured to, with the at least one processor, cause the apparatus to detect a program execution incident action set expansion trigger.

In some embodiments, the at least one memory and the program code are configured to, with the at least one processor, cause the apparatus to in response to detecting the program execution incident action set expansion trigger, reconfigure the program orchestration operations execution incident interface component to display one or more program subsidiary execution incident responsive action representations.

In some embodiments, the at least one memory and the program code are configured to, with the at least one processor, cause the apparatus to identify the program subsidiary execution incident output.

In some embodiments, the at least one memory and the program code are configured to, with the at least one processor, cause the apparatus to in response to identifying the program subsidiary execution incident output, reconfigure the program orchestration operations execution incident interface component to display a program subsidiary execution incident output indicator representation.

In some embodiments, the at least one memory and the program code are configured to, with the at least one processor, cause the apparatus to in response to causing execution of the first program subsidiary execution incident responsive action, reconfigure the program orchestration operations execution incident interface component to display a program subsidiary execution incident processing indicator representation.

In some embodiments, the at least one memory and the program code are configured to, with the at least one processor, cause the apparatus to detect a program subsidiary execution incident output expansion trigger.

In some embodiments, the at least one memory and the program code are configured to, with the at least one processor, cause the apparatus to in response to detecting the program subsidiary execution incident output expansion trigger, reconfigure the program subsidiary execution incident output interface component to display a program subsidiary execution incident output log representation.

In some embodiments, the at least one memory and the program code are configured to, with the at least one processor, cause the apparatus to generate a program orchestration operations repository incident interface component based on the program operations execution incident data.

In some embodiments, the program orchestration operations execution incident interface component comprises a plurality of program execution incident action set representations.

In some embodiments, the at least one memory and the program code are configured to, with the at least one processor, cause the apparatus to generate a program orchestration operations configuration incident interface component.

In some embodiments, the at least one memory and the program code are configured to, with the at least one processor, cause the apparatus to output the program orchestration operations configuration incident interface component for rendering to the program orchestration operations execution incident interface.

In some embodiments, the at least one memory and the program code are configured to, with the at least one processor, cause the apparatus to receive second program operations execution incident data via the program orchestration operations configuration incident interface component.

In some embodiments, program orchestration operations execution incident interface component comprises a program execution incident action set link.

In some embodiments, the at least one memory and the program code are configured to, with the at least one processor, cause the apparatus to output a program orchestration operations repository incident interface component for rendering to the program orchestration operations execution incident interface or a program orchestration operations configuration incident interface component for rendering to the program orchestration operations execution incident interface in response to receiving a selection of the program execution incident action set link.

In some embodiments, the automated program subsidiary execution incident engine is configured to execute the one or more program subsidiary execution incident responsive actions in accordance with at least one of a sequential program subsidiary execution incident responsive action execution operation, a temporal program subsidiary execution incident responsive action execution operation, an event program subsidiary execution incident responsive action execution operation, or a parallel program subsidiary execution incident responsive action execution operation.

In some embodiments, the at least one memory and the program code are configured to, with the at least one processor, cause the apparatus to train the automated program subsidiary execution incident engine based at least in part on historical program operations execution incident data or historical program subsidiary execution incident output.

In some embodiments, the program orchestration operations execution incident interface component comprises an operations execution incident event representation.

In some embodiments, the operations execution incident event is one or more of a computer processing unit execution rate event, a computing server execution error event, a computing network node error event, a software application execution error event, or a communication channel error event.

In some embodiments, the at least one memory and the program code are configured to, with the at least one processor, cause the apparatus to cause, using the automated program subsidiary execution incident engine, execution of a second program subsidiary execution incident responsive action of the one or more program subsidiary execution incident responsive actions.

In some embodiments, causing execution of the second program subsidiary execution incident responsive action comprises the program code being further configured to, with the at least one processor, cause the apparatus to identify an execution tag associated with the second program subsidiary execution incident responsive action.

In some embodiments, causing execution of the second program subsidiary execution incident responsive action comprises the program code being further configured to, with the at least one processor, cause the apparatus to compare the execution tag with an execution permission record feature associated with the second program subsidiary execution incident responsive action.

In some embodiments, causing execution of the second program subsidiary execution incident responsive action comprises the program code being further configured to, with the at least one processor, cause the apparatus to cause, using an automated program subsidiary execution incident engine, execution of the second program subsidiary execution incident responsive action.

In accordance with another aspect of the present disclosure, an example method for outputting a program subsidiary execution incident output interface component for rendering to a program orchestration operations execution incident interface is provided. In some embodiments, the method includes identifying an operations execution incident event. In some embodiments, the method includes accessing program operations execution incident data based on the operations execution incident event. In some embodiments, the program operations execution incident data is representative of a program execution incident action set. In some embodiments, the program execution incident action set comprises one or more program subsidiary execution incident responsive actions. In some embodiments, the method includes generating a program orchestration operations execution incident interface component based on the operations execution incident event and program operations execution incident data. In some embodiments, the program orchestration operations execution incident interface component comprises a program execution incident action set representation. In some embodiments, the program orchestration operations execution incident interface component comprises an operations execution incident event representation. In some embodiments, the method includes outputting the program orchestration operations execution incident interface component for rendering to a program orchestration operations execution incident interface. In some embodiments, the method includes causing, using an automated program subsidiary execution incident engine, execution of a first program subsidiary execution incident responsive action of the one or more program subsidiary execution incident responsive actions. In some embodiments, the method includes generating a program subsidiary execution incident output interface component. In some embodiments, the program subsidiary execution incident output interface component comprises a program subsidiary execution incident output representation associated with the first program subsidiary execution incident responsive action. In some embodiments, the program subsidiary execution incident output representation is indicative of a program subsidiary execution incident output. In some embodiments, the method includes outputting the program subsidiary execution incident output interface component for rendering to the program orchestration operations execution incident interface.

In some embodiments, the method includes detecting a program execution incident action set expansion trigger.

In some embodiments, the method includes in response to detecting the program execution incident action set expansion trigger, reconfiguring the program orchestration operations execution incident interface component to display one or more program subsidiary execution incident responsive action representations.

In some embodiments, the method includes identifying the program subsidiary execution incident output.

In some embodiments, the method includes in response to identifying the program subsidiary execution incident output, reconfiguring the program orchestration operations execution incident interface component to display a program subsidiary execution incident output indicator representation.

In some embodiments, the method includes in response to causing execution of the first program subsidiary execution incident responsive action, reconfiguring the program orchestration operations execution incident interface component to display a program subsidiary execution incident processing indicator representation.

In some embodiments, the method includes detecting a program subsidiary execution incident output expansion trigger.

In some embodiments, the method includes in response to detecting the program subsidiary execution incident output expansion trigger, reconfiguring the program subsidiary execution incident output interface component to display a program subsidiary execution incident output log representation.

In accordance with another exemplary embodiment of the present disclosure, a computer program product for outputting a program subsidiary execution incident output interface component for rendering to a program orchestration operations execution incident interface is provided. In some embodiments, the computer program product includes at least one non-transitory computer-readable storage medium having computer-readable program code portions stored therein, the computer-readable program code portions comprising an executable portion. In some embodiments, the computer-readable program code portions comprising an executable portion are configured to identify an operations execution incident event. In some embodiments, the computer-readable program code portions comprising an executable portion are configured to access program operations execution incident data based on the operations execution incident event. In some embodiments, the program operations execution incident data is representative of a program execution incident action set. In some embodiments, the program execution incident action set comprises one or more program subsidiary execution incident responsive actions. In some embodiments, the computer-readable program code portions comprising an executable portion are configured to generate a program orchestration operations execution incident interface component based on the operations execution incident event and program operations execution incident data. In some embodiments, the program orchestration operations execution incident interface component comprises a program execution incident action set representation. In some embodiments, the program orchestration operations execution incident interface component comprises a program execution incident action set link. In some embodiments, the computer-readable program code portions comprising an executable portion are configured to output the program orchestration operations execution incident interface component for rendering to a program orchestration operations execution incident interface. In some embodiments, the computer-readable program code portions comprising an executable portion are configured to cause, using an automated program subsidiary execution incident engine, execution of a first program subsidiary execution incident responsive action of the one or more program subsidiary execution incident responsive actions. In some embodiments, the computer-readable program code portions comprising an executable portion are configured to generate a program subsidiary execution incident output interface component. In some embodiments, the program subsidiary execution incident output interface component comprises a program subsidiary execution incident output representation associated with the first program subsidiary execution incident responsive action. In some embodiments, the program subsidiary execution incident output representation is indicative of a program subsidiary execution incident output. In some embodiments, the computer-readable program code portions comprising an executable portion are configured to output the program subsidiary execution incident output interface component for rendering to the program orchestration operations execution incident interface.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIG. 1 illustrates an example program orchestration operations execution incident system configured to communicate with various client devices in accordance with various example embodiments of the present disclosure;

FIG. 2 depicts a schematic block diagram of example circuitry to perform various operations in accordance with various example embodiments of the present disclosure;

FIG. 3 illustrates a program orchestration operations execution incident interface component in accordance with various example embodiments of the present disclosure;

FIG. 4 illustrates the program orchestration operations execution incident interface component in accordance with various example embodiments of the present disclosure;

FIG. 5 illustrates the program orchestration operations execution incident interface component in accordance with various example embodiments of the present disclosure;

FIG. 6 illustrates a program subsidiary execution incident output interface component in accordance with various example embodiments of the present disclosure;

FIG. 7 illustrates the program subsidiary execution incident output interface component in accordance with various example embodiments of the present disclosure;

FIG. 8 illustrates a program orchestration operations repository incident interface component in accordance with various example embodiments of the present disclosure;

FIG. 9 illustrates a program orchestration operations configuration incident interface component in accordance with various example embodiments of the present disclosure;

FIG. 10 depicts a flowchart diagram illustrating an example method in accordance with an example embodiment of the present disclosure;

FIG. 11 depicts a flowchart diagram illustrating an example method in accordance with an example embodiment of the present disclosure;

FIG. 12 depicts a flowchart diagram illustrating an example method in accordance with an example embodiment of the present disclosure; and

FIG. 13 depicts a flowchart diagram illustrating an example method in accordance with an example embodiment of the present disclosure.

### DETAILED DESCRIPTION

Example embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all embodiments of the present disclosure are shown and described herein. Indeed, embodiments of the disclosure may be embodied in many different forms, and accordingly this disclosure should not be construed as limited to the embodiments set forth herein; rather, these embodiments are provided so that this disclosure will satisfy applicable legal requirements.

### Overview

Methods, apparatuses, systems, and computer program products are provided in accordance with example embodiments of the present disclosure in order to enable efficient, reliable, dynamic, and secure implementation of program execution incident action sets and provisioning of various interface components, such as program orchestration operations execution incident interface components, program subsidiary execution incident output interface components, program orchestration operations repository incident interface components, program orchestration operations configuration incident interface components, and/or the like.

Software development systems (e.g., Jira Software® or Jira Service Management® by Atlassian) enable enterprises to plan, track, organize, schedule, address, repair, diagnose, execute, modify, transmit, and/or otherwise manage enterprise operations. For example, such software development systems may enable an enterprise to respond to operations execution incident events (e.g., excessive computing usage by a software application associated with the enterprise). In a program orchestration operations execution incident environment, it is desirable for software development systems to implement program execution incident action sets (e.g., playbooks) of interrelated program subsidiary execution incident responsive actions. For example, in a program orchestration operations execution incident environment, it is desirable to implement program execution incident action sets in order to enable response to operations execution incident events (e.g., to enable resolution of an operations execution incident event, such as excessive computing usage by a software application associated with the enterprise). However, many software development systems are associated with non-agile environments and, as a result, are simplistic and lack such capabilities. Thus, many software development systems have limited ability to implement program execution incident action sets in a program orchestration operations execution incident environment to enable complex and automated enterprise operations. As a result, it is not possible for software development systems to efficiently, dynamically, and reliably enable enterprise operations in a program orchestration operations execution incident environment.

In some examples, software development systems are not able to dynamically and efficiently enable various enterprise operations in a program orchestration operations execution incident environment because such software development systems are not able to provide tools to generate program execution incident action sets that may be used for responding to operations execution incident events. In order to address these technical challenges, the inventors have determined that it is desirable to provide a program orchestration operations configuration incident interface component. The program orchestration operations configuration incident interface component, for example, may be used to generate program execution incident action sets by enabling selection and organization of various program subsidiary execution incident responsive actions for responding to an operations execution incident event (e.g., program subsidiary execution incident responsive actions for responding to excessive computing usage by a software application). As a result, the program orchestration operations configuration incident interface component enables the dynamic and efficient implementation of enterprise operations in a program orchestration operations execution incident environment by enabling generation of program execution incident action sets.

In some examples, software development systems are not able to dynamically and efficiently enable various enterprise operations in a program orchestration operations execution incident environment because such software development systems are not able to provide tools to implement particular program execution incident action sets with identified operations execution incident events. In order to address these technical challenges, the inventors have determined that it is desirable to provide a program orchestration operations execution incident interface component. The program orchestration operations execution incident interface component, for example, may be used to implement a particular program execution incident action set with an identified operations execution incident event by recommending a particular program execution incident action set for responding to a particular operations execution incident event. Additionally, the program orchestration operations execution incident interface component, for example, may be used to cause execution of one or more program subsidiary execution incident responsive actions of a program execution incident action set for responding to an operations execution incident event (e.g., execution of a root cause analysis). As a result, the program orchestration operations execution incident interface component enables the dynamic and efficient implementation of enterprise operations in a program orchestration operations execution incident environment by enabling resolution of operations execution incident events using program execution incident action sets.

In some examples, software development systems are not able to dynamically and efficiently enable various enterprise operations in a program orchestration operations execution incident environment because such software development systems are not able to provide tools to assess performance of executed program execution incident action sets in response to identified operations execution incident events. In order to address these technical challenges, the inventors have determined that it is desirable to provide a program subsidiary execution incident output interface component. The program subsidiary execution incident output interface component, for example, may be used to assess a program subsidiary execution incident output of an executed program subsidiary execution incident responsive action. As a result, the program subsidiary execution incident output interface component enables the dynamic and efficient implementation of enterprise operations in a program orchestration operations execution incident environment by enabling assessment of executed program subsidiary execution incident responsive actions.

In some examples, software development systems are not able to dynamically and efficiently implement various enterprise operations in a program orchestration operations execution incident environment because such software development systems are not able to automate complex and interrelated program subsidiary execution incident responsive actions (e.g., executing program subsidiary execution incident responsive actions using a sequential program subsidiary execution incident responsive action execution operation). In order to address these technical challenges, the inventors have determined that it is desirable to implement an automated program subsidiary execution incident engine (e.g., having and/or using a rules-based or machine learning model) that is configured to execute program subsidiary execution incident responsive actions in a particular program execution incident action set. As a result, the automated program subsidiary execution incident engine enables the dynamic and efficient implementation of enterprise operations in a program orchestration operations execution incident environment by enabling execution of program subsidiary execution incident responsive actions in a particular program execution incident action set.

### Definitions

The following explanations of terms are provided to better describe the present disclosure and to guide those of ordinary skill in the art in the practice of the present disclosure.

As used herein, the term “program orchestration operations execution incident system” refers to the software platform(s) and associated hardware configured to support and maintain a plurality of projects, workflows, and all associated functionality. For example, a program orchestration operations execution incident system may comprise a software product such as Jira® by Atlassian®. Example program orchestration operations execution incident systems comprise supporting server(s) and repositor(ies), and in some embodiments, are further configured to engage with internal resources, external resources, internal applications, and/or external applications.

As used herein, the term “program orchestration operations execution incident server” refers to a software platform and associated hardware that is configured to, inter alia, manage the various interfaces and/or interface components and associated functionality of the program orchestration operations execution incident system. For example, in some embodiments, the program orchestration operations execution incident server is configured to generate, manage, output, and/or update program orchestration operations execution incident interface components, program subsidiary execution incident output interface components, program orchestration operations repository incident interface components, program orchestration operations configuration incident interface components, and/or the like.

As another example, in some embodiments, the program orchestration operations execution incident server is configured to receive, identify, determine, generate, and/or output program operations execution incident data and/or historical program operations execution incident data. As another example, in some embodiments, the program orchestration operations execution incident server is configured to generate, perform, cause, initiate, execute, and/or implement program subsidiary execution incident responsive actions and/or program execution incident action sets.

As used herein, the terms “program orchestration operations execution incident application” or “program orchestration operations execution incident system app” refer to a dedicated software program, application, platform, service, web browser, or computer-executable application software programmed or configured to run on a client device which provides a user access to the program orchestration operations execution incident system and its associated functionality. In some embodiments, the program orchestration operations execution incident application may include hardware, software, or combinations thereof operating remotely (e.g., on a server). In some embodiments, the program orchestration operations execution incident application is designed to execute on mobile devices, such as tablets or smartphones. For example, in certain embodiments, an app is provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

As used herein, the term “program orchestration operations execution incident data repository” refers to a location, such as a database stored on a memory device, which is accessible by one or more computing devices for retrieval and storage of data associated with the program orchestration operations execution incident system. For example, the program orchestration operations execution incident data repository may include program operations execution incident data and/or historical program operations execution incident data. As another example, the program orchestration operations execution incident data repository may include program subsidiary execution incident responsive actions and/or program execution incident action sets. The program orchestration operations execution incident data repository may be a dedicated device and/or part of a larger repository. The program orchestration operations execution incident data repository may be dynamically updated or be static. In some embodiments, the program orchestration operations execution incident data repository is encrypted in order to limit unauthorized access of data associated with the program orchestration operations execution incident system.

As used herein, the term “operations execution incident event” refers to a problem, error, fault, and/or the like associated with a software application and/or computing device that requires analysis, diagnosis, repair, resolution, and/or the like by a program orchestration operations execution incident system and/or a user associated with a program orchestration operations execution incident system. Additionally, or alternatively, an operations execution incident event refers to an actionable item, work item, issue, and/or task that may be performed by a program orchestration operations execution incident system and/or a user associated with a program orchestration operations execution incident system. For example, an operations execution incident event may include an actionable item, work item, issue, and/or task that is performed in order to perform employee onboarding (e.g., generating user documents, generating a user ticket, selecting user software, generating facility access documentation, user workstation set up documentation, associating a user with relevant team members), accounting tasks, enterprise tasks, and/or the like.

In some embodiments, an operations execution incident event is a computer processing unit execution rate event. Additionally, or alternatively, an operations execution incident event is a computing server execution error event. Additionally, or alternatively, an operations execution incident event is a computing network node error event. Additionally, or alternatively, an operations execution incident event is a software application execution error event. Additionally, or alternatively, an operations execution incident event is a communication channel error event.

In some embodiments, a program orchestration operations execution incident system is configured to identify an operations execution incident event by identifying data that describes the operations execution incident event. For example, a program orchestration operations execution incident system may be configured to identify an operations execution incident event by identifying data from a software application and/or a computing device that is being impacted by an operations execution incident event and/or a user associated with a software application and/or a computing device that is being impacted by an operations execution incident event.

As used herein, the term “computer processing unit execution rate event” refers to a problem, error, fault, and/or the like that includes high computer processing unit (CPU) usage and that requires analysis, diagnosis, repair, resolution, and/or the like by a program orchestration operations execution incident system and/or a user associated with a program orchestration operations execution incident system. For example, a computer processing unit execution rate event may include a computer processing unit (CPU) usage above 80%.

As used herein, the term “computing server execution error event” refers to a problem, error, fault, and/or the like that includes a server being unable to execute a computing task and that requires analysis, diagnosis, repair, resolution, and/or the like by a program orchestration operations execution incident system and/or a user associated with a program orchestration operations execution incident system. For example, a computing server execution error event may include a server being unable to retrieve data from a data source.

As used herein, the term “computing network node error event” refers to a problem, error, fault, and/or the like that includes a network node being unable to facilitate a connection between one or more computing devices associated with the network node and that requires analysis, diagnosis, repair, resolution, and/or the like by a program orchestration operations execution incident system and/or a user associated with a program orchestration operations execution incident system. For example, a computing network node error event may include a gateway being unable to facilitate a connection between one or more computing devices associated with the gateway.

As used herein, the term “software application execution error event” refers to a problem, error, fault, and/or the like that includes a software application being unable to execute a task and that requires analysis, diagnosis, repair, resolution, and/or the like by a program orchestration operations execution incident system and/or a user associated with a program orchestration operations execution incident system. For example, a software application execution error event may include a software application being unable to track interactions with the software application and/or other software applications.

As used herein, the term “communication channel error event” refers to a problem, error, fault, and/or the like that includes a software application and/or computing device being unable to connect to other software applications and/or computing devices via a particular communication channel and that requires analysis, diagnosis, repair, resolution, and/or the like by a program orchestration operations execution incident system and/or a user associated with a program orchestration operations execution incident system. For example, a communication channel error event may include a software application and/or computing device being unable to use a communication channel to connect to a server.

As used herein, the term “operations execution incident event representation” refers to one or more of text, images, or other visual elements that are indicative of an operations execution incident event. An operations execution incident event representation is renderable to a visual display, such as an interface component, of a computing device as part of a user interface, or usable to configure and/or fill content of a visual element renderable to a visual display of a computing device as part of a user interface. For example, an operations execution incident event representation may be renderable to a program orchestration operations execution incident interface component.

As used herein, the term “automated program subsidiary execution incident engine” refers to a software application configured to at least in part cause execution of one or more program subsidiary execution incident responsive actions. For example, an automated program subsidiary execution incident engine may be a software application configured to at least in part cause execution of one or more triaging actions, root cause analysis actions, remediation actions, dissemination actions, and/or the like. In some embodiments, an automated program subsidiary execution incident engine may be configured based at least in part on program operations execution incident data and/or historical program operations execution incident data. In this regard, an automated program subsidiary execution incident engine may be a software application configured to at least in part cause execution of one or more program subsidiary execution incident responsive actions based at least in part program operations execution incident data and/or historical program operations execution incident data.

In some embodiments, an automated program subsidiary execution incident engine may include a machine learning model. In this regard, the machine learning model of an automated program subsidiary execution incident engine may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to be used to perform one or more operations described herein, such as to cause execution of one or more program subsidiary execution incident responsive actions. In this regard, in some embodiments, the machine learning model of an automated program subsidiary execution incident engine may be configured to utilize one or more of any type of machine learning, rules-based, and/or artificial intelligence techniques including one or more of computer vision techniques, image processing techniques, optical character recognition techniques, supervised learning (e.g., using user feedback), unsupervised learning, semi-supervised learning, reinforcement learning, sequence modeling techniques, language processing techniques, neural network techniques, and/or generative artificial intelligence techniques.

In some embodiments, an automated program subsidiary execution incident engine may be configured to be trained. In some embodiments, an automated program subsidiary execution incident engine may be configured to be trained based at least in part on program operations execution incident data and/or historical program operations execution incident data. In this regard, for example, a machine learning model of an automated program subsidiary execution incident engine may be configured to be trained using program operations execution incident data and/or historical program operations execution incident data. In some embodiments, an automated program subsidiary execution incident engine may be executed and/or used by a program orchestration operations execution incident system (e.g., a program orchestration operations execution incident server) to cause execution of one or more program subsidiary execution incident responsive actions.

In some embodiments, an automated program subsidiary execution incident engine is configured to execute one or more program subsidiary execution incident responsive actions in accordance with at least one of a sequential program subsidiary execution incident responsive action execution operation, a temporal program subsidiary execution incident responsive action execution operation, an event program subsidiary execution incident responsive action execution operation, or a parallel program subsidiary execution incident responsive action execution operation.

As used herein, the term “sequential program subsidiary execution incident responsive action execution operation” refers to a sequential-related procedure used by an automated program subsidiary execution incident engine for causing execution of one or more program subsidiary execution incident responsive actions. In this regard, in some embodiments, a sequential-related procedure by an automated program subsidiary execution incident engine for causing execution of one or more program subsidiary execution incident responsive actions includes the automated program subsidiary execution incident engine being configured to cause execution of a first program subsidiary execution incident responsive action, determine that the first program subsidiary execution incident responsive action is complete, and cause execution of a second program subsidiary execution incident responsive action in response to determining that the first program subsidiary execution incident responsive action is complete.

As used herein, the term “temporal program subsidiary execution incident responsive action execution operation” refers to a temporal-related procedure used by an automated program subsidiary execution incident engine for causing execution of one or more program subsidiary execution incident responsive actions. In this regard, in some embodiments, a temporal-related procedure by an automated program subsidiary execution incident engine for causing execution of one or more program subsidiary execution incident responsive actions includes the automated program subsidiary execution incident engine being configured to identify a first program subsidiary execution incident responsive action associated with an execution delay time period, determine that the execution delay time period has occurred, and cause execution of the first program subsidiary execution incident responsive action in response to determining that the execution delay time period has occurred. In some embodiments, an execution delay time period is a timeboxed period, time interval, and/or unit of time that occurs before a program subsidiary execution incident responsive action is caused to execute.

As used herein, the term “event program subsidiary execution incident responsive action execution operation” refers to an event-related procedure used by an automated program subsidiary execution incident engine for causing execution of one or more program subsidiary execution incident responsive actions. In this regard, in some embodiments, an event-related procedure by an automated program subsidiary execution incident engine for causing execution of one or more program subsidiary execution incident responsive actions includes the automated program subsidiary execution incident engine being configured identify a first program subsidiary execution incident responsive action associated with an execution delay program event, determine that the execution delay program event has occurred, and cause execution of the first program subsidiary execution incident responsive action in response to determining that the execution delay program event has occurred. In some embodiments, an execution delay program event is an event that occurs before a program subsidiary execution incident responsive action is caused to execute.

As used herein, the term “parallel program subsidiary execution incident responsive action execution operation” refers to a parallel-related procedure used by an automated program subsidiary execution incident engine for causing execution of one or more program subsidiary execution incident responsive actions. In this regard, in some embodiments, an parallel-related procedure by an automated program subsidiary execution incident engine for causing execution of one or more program subsidiary execution incident responsive actions includes the automated program subsidiary execution incident engine being configured to cause execution of a first program subsidiary execution incident responsive action during a first time period and cause execution of a second program subsidiary execution incident responsive action during the first time period.

As used herein, the term “program subsidiary execution incident responsive action” refers to an action that may be performed by a program orchestration operations execution incident system and/or a user associated with a program orchestration operations execution incident system in response to an operations execution incident event. In this regard, in some embodiments, a program subsidiary execution incident responsive action is an action that may be performed by a program orchestration operations execution incident system and/or a user associated with a program orchestration operations execution incident system in response to an operations execution incident event to analyze, diagnosis, repair, resolve, and/or the like the operations execution incident event. In some embodiments, a program subsidiary execution incident responsive action is caused to execute by an automated program subsidiary execution incident engine. In this regard, for example, a program orchestration operations execution incident system and/or a user associated with a program orchestration operations execution incident system may use an automated program subsidiary execution incident engine to execute a program subsidiary execution incident responsive action.

In some embodiments, a program subsidiary execution incident responsive action may include a triaging action in which an operations execution incident event is triaged. For example, a triaging action may include allocating appropriate resources for responding to an operations execution incident event (e.g., computing resources and/or technical resources). In some embodiments, a program subsidiary execution incident responsive action may include a root cause analysis action in which a root cause of an operations execution incident event is identified. For example, a root cause analysis action may include identifying a processing error that is causing excessive CPU usage. In some embodiments, a program subsidiary execution incident responsive action may include a remediation action in which a remedial process is performed to remedy an operations execution incident event. For example, a remediation action may include causing a restart of a software application associated with an operations execution incident event. In some embodiments, a program subsidiary execution incident responsive action may include a dissemination action in which documentation about an operations execution incident event is generated and/or shared. For example, a dissemination action may include generating documentation indicating the root cause of an operations execution incident event.

As used herein, the term “program subsidiary execution incident responsive action representation” refers to one or more of text, images, or other visual elements that are indicative of one or more program subsidiary execution incident responsive actions. A program subsidiary execution incident responsive action representation is renderable to a visual display, such as an interface component, of a computing device as part of a user interface, or usable to configure and/or fill content of a visual element renderable to a visual display of a computing device as part of a user interface. For example, a program subsidiary execution incident responsive action representation may be renderable to a program orchestration operations execution incident interface component.

As used herein, the term “program execution incident action set” refers to a collection of program subsidiary execution incident responsive actions. In this regard, in some embodiments, a program execution incident action set is a collection of program subsidiary execution incident responsive actions that may be performed by a program orchestration operations execution incident system and/or a user associated with a program orchestration operations execution incident system in response to an operations execution incident event to analyze, diagnosis, repair, resolve, and/or the like the operations execution incident event. In some embodiments, a program execution incident action set is referred to as a “playbook”. Additionally, or alternatively, a program execution incident action set is referred to as “PEIAS”. In some embodiments, a program execution incident action set is accessible and/or usable by multiple users associated with a program orchestration operations execution incident system simultaneously. In this regard, for example, a single instance of a program execution incident action set may be used by multiple users associated with a program orchestration operations execution incident system simultaneously in response to an operations execution incident event. In some embodiments, a program execution incident action set includes one or more of an identifier feature, a scope feature, a user feature, a type feature, an operational feature, a status feature, an execution permission record feature, and/or the like.

As used herein, the term “identifier feature” refers to one or more items of data that uniquely identify a program execution incident action set in a program orchestration operations execution incident system. In this regard, in some embodiments, an identifier feature may comprise one or more of ASCII text, encryption keys, identification certificates, a pointer, an IP address, a URL, a MAC address, a memory address, or other unique identifier, or combinations thereof that uniquely identify a program execution incident action set in a program orchestration operations execution incident system. For example, an identifier feature may be a name or a title of a program execution incident action set.

As used herein, the term “identifier feature representation” refers to one or more of text, images, or other visual elements that are indicative of an identifier feature. An identifier feature representation is renderable to a visual display, such as an interface component, of a computing device as part of a user interface, or usable to configure and/or fill content of a visual element renderable to a visual display of a computing device as part of a user interface. For example, an identifier feature representation may be renderable to a program orchestration operations repository incident interface component.

As used herein, the term “scope feature” refers to one or more items of data that identify one or more software applications and/or computing devices that a program execution incident action set is associated with. In this regard, for example, a scope feature may identify one or more software applications and/or computing devices that a program execution incident action set may be used to remedy an operations execution incident event associated with the one or more software applications and/or computing devices. For example, a scope feature may identify an adapter computing system (e.g., a payments adapter computing system).

As used herein, the term “scope feature representation” refers to one or more of text, images, or other visual elements that are indicative of a scope feature. A scope feature representation is renderable to a visual display, such as an interface component, of a computing device as part of a user interface, or usable to configure and/or fill content of a visual element renderable to a visual display of a computing device as part of a user interface. For example, a scope feature representation may be renderable to a program orchestration operations repository incident interface component.

As used herein, the term “user feature” refers to one or more items of data that identify one or more users associated with a program execution incident action set. For example, a user feature may identify a user that created a program execution incident action set. As another example, a user feature may identify a user that is currently using a program execution incident action set. As another example, a user feature may identify a user that most recently updated a program execution incident action set.

As used herein, the term “user feature representation” refers to one or more of text, images, or other visual elements that are indicative of a user feature. A user feature representation is renderable to a visual display, such as an interface component, of a computing device as part of a user interface, or usable to configure and/or fill content of a visual element renderable to a visual display of a computing device as part of a user interface. For example, a user feature representation may be renderable to a program orchestration operations repository incident interface component.

As used herein, the term “type feature” refers to one or more items of data that identify a type of operations execution incident event associated with a program execution incident action set. In this regard, in some embodiments, a type feature may identify types of operations execution incident event that may be resolved using a program execution incident action set. For example, a type feature may identify that a program execution incident action set may be used to remedy a computer processing unit execution rate event, a computing network node error event, a software application execution error event, a communication channel error event, and/or the like.

As used herein, the term “type feature representation” refers to one or more of text, images, or other visual elements that are indicative of a type feature. A type feature representation is renderable to a visual display, such as an interface component, of a computing device as part of a user interface, or usable to configure and/or fill content of a visual element renderable to a visual display of a computing device as part of a user interface. For example, a type feature representation may be renderable to a program orchestration operations repository incident interface component.

As used herein, the term “operational feature” refers to one or more items of data that identify an operational status of a program execution incident action set. In this regard, in some embodiments, an operational feature may identify that a program execution incident action set is associated with an operational status that indicates that program execution incident action set is functioning without any problems, errors, faults, and/or the like (e.g., all rules working). Additionally, or alternatively, an operational feature may identify that a program execution incident action set is associated with an operational status that indicates that program execution incident action set is functioning with one or more problems, errors, faults, and/or the like (e.g., 1 rule not working).

As used herein, the term “operational feature representation” refers to one or more of text, images, or other visual elements that are indicative of an operational feature. An operational feature representation is renderable to a visual display, such as an interface component, of a computing device as part of a user interface, or usable to configure and/or fill content of a visual element renderable to a visual display of a computing device as part of a user interface. For example, an operational feature representation may be renderable to a program orchestration operations repository incident interface component.

As used herein, the term “status feature” refers to one or more items of data that identify a status of a program execution incident action set. In this regard, in some embodiments, a status feature may identify that a program execution incident action set is able to be used to remedy an operations execution incident event. Additionally, or alternatively, status feature may identify that a program execution incident action set is not able to be used to remedy an operations execution incident event.

As used herein, the term “status feature representation” refers to one or more of text, images, or other visual elements that are indicative of a status feature. A status feature representation is renderable to a visual display, such as an interface component, of a computing device as part of a user interface, or usable to configure and/or fill content of a visual element renderable to a visual display of a computing device as part of a user interface. For example, a status feature representation may be renderable to a program orchestration operations repository incident interface component.

As used herein, the term “execution tag” refers to one or more items of data that identify a user that is attempting to cause execution of a program subsidiary execution incident responsive action.

As used herein, the term “execution permission record feature” refers to one or more items of data that identify one or more execution tags that have permission to cause execution of program subsidiary execution incident responsive actions in a program execution incident action set.

As used herein, the term “program operations execution incident data” refers to one or more items of data indicative of one or more program execution incident action sets. In this regard, in some embodiments, program operations execution incident data includes one or more items of data indicative of one or more program subsidiary execution incident responsive actions in a program execution incident action set. Additionally, or alternatively, program operations execution incident data includes one or more items of data indicative of one or more identifier features, scope features, user features, type features, operational features, status features, execution permission record features, and/or the like associated with a program execution incident action set. In some embodiments, program operations execution incident data is stored in a program orchestration operations execution incident data repository.

As used herein, the term “historical program operations execution incident data” refers to one or more items of data indicative of one or more historical program execution incident action sets (e.g., previously generated or implemented program execution incident action sets). In this regard, in some embodiments, historical program operations execution incident data includes one or more items of data indicative of one or more historical program subsidiary execution incident responsive actions in a historical program execution incident action set. Additionally, or alternatively, historical program operations execution incident data includes one or more items of data indicative of one or more historical identifier features, historical scope features, historical user features, historical type features, historical operational features, historical status features, historical execution permission record features, and/or the like associated with a historical program execution incident action set. In some embodiments, historical program operations execution incident data is stored in a program orchestration operations execution incident data repository.

As used herein, the term “program subsidiary execution incident output” refers to one or more items of data that are generated by causing execution of a program subsidiary execution incident responsive action and/or describe a program subsidiary execution incident responsive action that has been caused to execute. In this regard, in some embodiments, a program subsidiary execution incident output includes one or more items of data indicative of a result and/or description of causing execution of a program subsidiary execution incident responsive action. For example, a program subsidiary execution incident output may include one or more items of data indicative of a result and/or description of causing execution of one or more triaging actions, root cause analysis actions, remediation actions, dissemination actions, and/or the like. In some embodiments, a program subsidiary execution incident output comprises one or more of a temporal partial program subsidiary execution incident output, a user partial program subsidiary execution incident output, an outcome partial program subsidiary execution incident output, a duration partial program subsidiary execution incident output, and/or the like.

As used herein, the term “historical program subsidiary execution incident output” refers to one or more items of data that are generated by causing execution of a historical program subsidiary execution incident responsive action and/or describe a historical program subsidiary execution incident responsive action that has been caused to execute. In this regard, in some embodiments, a historical program subsidiary execution incident output includes one or more items of data indicative of a result and/or description of causing execution of a historical program subsidiary execution incident responsive action. For example, a historical program subsidiary execution incident output may include one or more items of data indicative of a result and/or description of causing execution of one or more historical triaging actions, historical root cause analysis actions, historical remediation actions, historical dissemination actions, and/or the like. In some embodiments, a historical program subsidiary execution incident output comprises one or more of a historical temporal partial program subsidiary execution incident output, a historical user partial program subsidiary execution incident output, a historical outcome partial program subsidiary execution incident output, a historical duration partial program subsidiary execution incident output, and/or the like.

As used herein, the term “program subsidiary execution incident output representation” refers to one or more of text, images, or other visual elements that are indicative of a program subsidiary execution incident output. A program subsidiary execution incident output representation is renderable to a visual display, such as an interface component, of a computing device as part of a user interface, or usable to configure and/or fill content of a visual element renderable to a visual display of a computing device as part of a user interface. For example, a program subsidiary execution incident output representation may be renderable to a program subsidiary execution incident output interface component.

As used herein, the term “temporal partial program subsidiary execution incident output” refers to one or more items of data indicative of a time and/or date at which a program subsidiary execution incident output is generated by causing execution of a program subsidiary execution incident responsive action.

As used herein, the term “temporal partial program subsidiary execution incident output representation” refers to one or more of text, images, or other visual elements that are indicative of a temporal partial program subsidiary execution incident output. A temporal partial program subsidiary execution incident output representation is renderable to a visual display, such as an interface component, of a computing device as part of a user interface, or usable to configure and/or fill content of a visual element renderable to a visual display of a computing device as part of a user interface. For example, a temporal partial program subsidiary execution incident output representation may be renderable to a program subsidiary execution incident output interface component.

As used herein, the term “user partial program subsidiary execution incident output” refers to one or more items of data indicative of a user associated with a program subsidiary execution incident output that was generated by causing execution of a program subsidiary execution incident responsive action.

As used herein, the term “user partial program subsidiary execution incident output representation” refers to one or more of text, images, or other visual elements that are indicative of a user partial program subsidiary execution incident output. A user partial program subsidiary execution incident output representation is renderable to a visual display, such as an interface component, of a computing device as part of a user interface, or usable to configure and/or fill content of a visual element renderable to a visual display of a computing device as part of a user interface. For example, a user partial program subsidiary execution incident output representation may be renderable to a program subsidiary execution incident output interface component.

As used herein, the term “outcome partial program subsidiary execution incident output” refers to one or more items of data indicative of an outcome associated with a program subsidiary execution incident output that was generated by causing execution of a program subsidiary execution incident responsive action. For example, an outcome partial program subsidiary execution incident output may indicate that a program subsidiary execution incident responsive action was successful. As another example, an outcome partial program subsidiary execution incident output may indicate that a program subsidiary execution incident responsive action was a failure.

As used herein, the term “outcome partial program subsidiary execution incident output representation” refers to one or more of text, images, or other visual elements that are indicative of an outcome partial program subsidiary execution incident output. An outcome partial program subsidiary execution incident output representation is renderable to a visual display, such as an interface component, of a computing device as part of a user interface, or usable to configure and/or fill content of a visual element renderable to a visual display of a computing device as part of an outcome interface. For example, a user partial program subsidiary execution incident output representation may be renderable to a program subsidiary execution incident output interface component.

As used herein, the term “duration partial program subsidiary execution incident output” refers to one or more items of data indicative of an amount of time that it took to generate a program subsidiary execution incident output by causing execution of a program subsidiary execution incident responsive action. For example, a duration partial program subsidiary execution incident output may indicate an amount of time that it took a program orchestration operations execution incident system to generate a program subsidiary execution incident output by causing execution of a program subsidiary execution incident responsive action.

As used herein, the term “duration partial program subsidiary execution incident output representation” refers to one or more of text, images, or other visual elements that are indicative of a duration partial program subsidiary execution incident output. A duration partial program subsidiary execution incident output representation is renderable to a visual display, such as an interface component, of a computing device as part of a user interface, or usable to configure and/or fill content of a visual element renderable to a visual display of a computing device as part of a user interface. For example, a duration partial program subsidiary execution incident output representation may be renderable to a program subsidiary execution incident output interface component.

As used herein, the term “program execution incident action set link” refers to a selectable data object that facilitates transfer between one or more interface components. In this regard, in some embodiments, a program execution incident action set link is a data object rendered on an interface component that is rendered on a program orchestration operations execution incident interface that, when selected, causes a different interface component to be rendered on a program orchestration operations execution incident interface. For example, a program execution incident action set link may be a data object rendered on a program orchestration operations execution incident interface component that, when selected, causes a program orchestration operations repository incident interface component to be rendered on a program orchestration operations execution incident interface. As another example, a program execution incident action set link may be a data object rendered on a program orchestration operations execution incident interface component that, when selected, causes a program orchestration operations configuration incident interface component to be rendered on a program orchestration operations execution incident interface. As another example, a program execution incident action set link may be a data object rendered on a program subsidiary execution incident output interface component that, when selected, causes a program orchestration operations repository incident interface component to be rendered on a program orchestration operations execution incident interface. As another example, a program execution incident action set link may be a data object rendered on a program subsidiary execution incident output interface component that, when selected, causes a program orchestration operations configuration incident interface component to be rendered on a program orchestration operations execution incident interface.

As used herein, the term “program execution incident action set expansion trigger” refers to an event that causes a program orchestration operations execution incident interface component to be reconfigured to display one or more program subsidiary execution incident responsive action representations. In this regard, in some embodiments, program execution incident action set expansion trigger is an event that causes a program orchestration operations execution incident interface component to be reconfigured to display one or more program subsidiary execution incident responsive action representations when the program orchestration operations execution incident interface component was not previously displaying the one or more program subsidiary execution incident responsive action representations. In some embodiments, a program orchestration operations execution incident system is configured to detect a program execution incident action set expansion trigger by detecting and/or identifying data indicative of the program execution incident action set expansion trigger.

In some embodiments, a program execution incident action set expansion trigger may be an event that includes an instruction, such as user selection. In this regard, for example, a program execution incident action set expansion trigger may be an instruction, such as a user selection, that that causes a program orchestration operations execution incident interface component to be reconfigured to display one or more program subsidiary execution incident responsive action representations. In some embodiments, a program execution incident action set expansion trigger may be an event that includes an occurrence of an amount of time. In this regard, for example, a program execution incident action set expansion trigger may an occurrence of an amount of time that causes a program orchestration operations execution incident interface component to be reconfigured to display one or more program subsidiary execution incident responsive action representations. In some embodiments, a program execution incident action set expansion trigger may be an event that includes causing execution of a first program subsidiary execution incident responsive action. In this regard, for example, a program execution incident action set expansion trigger may be causing execution of an action that causes a program orchestration operations execution incident interface component to be reconfigured to display one or more program subsidiary execution incident responsive action representations.

As used herein, the term “program subsidiary execution incident output indicator representation” refers to one or more of text, images, or other visual elements that are indicative of a completion of a program subsidiary execution incident responsive action. For example, a program subsidiary execution incident output indicator representation may be one or more of text, images, or other visual elements that indicates that a program subsidiary execution incident responsive action was completed at a particular time. In some embodiments, a program subsidiary execution incident output indicator representation is displayed on a program orchestration operations execution incident interface component. In some embodiments, a program subsidiary execution incident output indicator representation is configured to be updated in real-time (e.g., upon completion of a program subsidiary execution incident responsive action.

As used herein, the term “program subsidiary execution incident processing indicator representation” refers to one or more of text, images, or other visual elements that are indicative of a program subsidiary execution incident responsive action that is in progress. For example, a program subsidiary execution incident processing indicator representation may be one or more of text, images, or other visual elements that indicates that a program subsidiary execution incident responsive action is currently in progress. In some embodiments, a program subsidiary execution incident processing indicator representation is displayed on a program orchestration operations execution incident interface component. In some embodiments, a program subsidiary execution incident processing indicator representation is configured to be updated in real-time (e.g., upon execution of a program subsidiary execution incident responsive action).

As used herein, the term “program orchestration operations execution incident interface” refers to a graphical user interface of a program orchestration operations execution incident system that is configured to enable one or more users to view and engage with one or more program orchestration operations execution incident workspaces, views, and/or interface components. In some embodiments, for example, a program orchestration operations execution incident interface is configured to enable one or more users to view and engage with one or more program orchestration operations execution incident interface components, program subsidiary execution incident output interface components, program orchestration operations repository incident interface components, program orchestration operations configuration incident interface components, and/or the like. In some embodiments, a program orchestration operations execution incident interface may be rendered to a client device based on data provided by or to a program orchestration operations execution incident system. In some embodiments, such data and instructions are facilitated by a dedicated software application running on the client device. In other embodiments, such data and instructions are provided through a web browser running on the client device.

As used herein, the term “program orchestration operations execution incident interface component” refers to a graphical user interface element that is rendered to or as a portion of, a program orchestration operations execution incident interface of a program orchestration operations execution incident system. In some embodiments, a program orchestration operations execution incident interface component may be configured to display a program execution incident action set representation. Additionally, or alternatively, a program orchestration operations execution incident interface component may be configured to display a program execution incident action set link. Additionally, or alternatively, the program orchestration operations execution incident interface component may be configured to display an operations execution incident event representation.

Additionally, or alternatively, a program orchestration operations execution incident interface component may be configured to display one or more program subsidiary execution incident responsive action representations. For example, a program orchestration operations execution incident interface component may be reconfigured to display one or more program subsidiary execution incident responsive action representations in response to a program orchestration operations execution incident system detecting a program execution incident action set expansion trigger. Additionally, or alternatively, a program orchestration operations execution incident interface component may be configured to display a program subsidiary execution incident output indicator representation. For example, a program orchestration operations execution incident interface component may be reconfigured to display a program subsidiary execution incident output indicator representation in response to a program orchestration operations execution incident system identifying a program subsidiary execution incident output. Additionally, or alternatively, a program orchestration operations execution incident interface component may be configured to display a program subsidiary execution incident processing indicator representation. For example, a program orchestration operations execution incident interface component may be reconfigured to display a program subsidiary execution incident processing indicator representation in response to a program orchestration operations execution incident system causing execution of a program subsidiary execution incident responsive action.

As used herein, the term “program subsidiary execution incident output log representation” refers to one or more of text, images, or other visual elements that are indicative of a log of an executed program subsidiary execution incident responsive action. For example, a program subsidiary execution incident output indicator representation may be one or more of text, images, or other visual elements that indicates an issue key associated with an executed program subsidiary execution incident responsive action. As another example, a program subsidiary execution incident output indicator representation may be one or more of text, images, or other visual elements that indicates a query associated with an executed program subsidiary execution incident responsive action. As another example, a program subsidiary execution incident output indicator representation may be one or more of text, images, or other visual elements that indicates a numerical associated with an executed program subsidiary execution incident responsive action. As another example, a program subsidiary execution incident output indicator representation may be one or more of text, images, or other visual elements that indicates a runbook associated with an executed program subsidiary execution incident responsive action. In some embodiments, a program subsidiary execution incident output indicator representation is displayed on a program subsidiary execution incident output interface component.

As used herein, the term “program subsidiary execution incident output expansion trigger” refers to an event that causes a program subsidiary execution incident output interface component to be reconfigured to display a program subsidiary execution incident output log representation. In this regard, in some embodiments, program subsidiary execution incident output expansion trigger is an event that causes a program subsidiary execution incident output interface component to be reconfigured to display a program subsidiary execution incident output log representation when the program subsidiary execution incident output interface component was not previously displaying the program subsidiary execution incident output log representation. In some embodiments, a program orchestration operations execution incident system is configured to detect a program subsidiary execution incident output expansion trigger by detecting and/or identifying data indicative of the program subsidiary execution incident output expansion trigger.

In some embodiments, a program subsidiary execution incident output expansion trigger may be an event that includes an instruction, such as user selection. In this regard, for example, a program subsidiary execution incident output expansion trigger may be an instruction, such as a user selection, that that causes a program subsidiary execution incident output interface component to be reconfigured to display a program subsidiary execution incident output log representation. In some embodiments, a program subsidiary execution incident output expansion trigger may be an event that includes an occurrence of an amount of time. In this regard, for example, a program subsidiary execution incident output expansion trigger may an occurrence of an amount of time that causes a program subsidiary execution incident output interface component to be reconfigured to display a program subsidiary execution incident output log representation. In some embodiments, a program subsidiary execution incident output expansion trigger may be an event that includes causing execution of a first program subsidiary execution incident responsive action. In this regard, for example, a program subsidiary execution incident output expansion trigger may be causing execution of an action that causes a program subsidiary execution incident output interface component to be reconfigured to display a program subsidiary execution incident output log representation.

As used herein, the term “program subsidiary execution incident output interface component” refers to a graphical user interface element that is rendered to or as a portion of, a program orchestration operations execution incident interface of a program orchestration operations execution incident system. In some embodiments, a program subsidiary execution incident output interface component may be configured to display a program subsidiary execution incident output representation. In this regard, in some embodiments, a program subsidiary execution incident output interface component may be configured to display one or more of a temporal partial program subsidiary execution incident output representation, a user partial program subsidiary execution incident output representation, an outcome partial program subsidiary execution incident output representation, a duration partial program subsidiary execution incident output representation, and/or the like. Additionally, or alternatively, a program subsidiary execution incident output interface component may be configured to display a program subsidiary execution incident output log representation. For example, a program subsidiary execution incident output interface component may be reconfigured to display a program subsidiary execution incident output log representation in response to a program orchestration operations execution incident system detecting a program subsidiary execution incident output expansion trigger.

As used herein, the term “program orchestration operations repository incident interface component” refers to a graphical user interface element that is rendered to or as a portion of, a program orchestration operations execution incident interface of a program orchestration operations execution incident system. In some embodiments, a program orchestration operations repository incident interface component may be configured to display a program execution incident action set representation. In this regard, in some embodiments, a program orchestration operations repository incident interface component may be configured to display one or more of an identifier feature representation, a scope feature representation, a user feature representation, a type feature representation, an operational feature representation, a status feature representation, an execution permission record feature representation, a program execution incident action set representation, and/or the like.

As used herein, the term “predicted program subsidiary execution incident responsive action” refers to an action that may be performed by a program orchestration operations execution incident system and/or a user associated with a program orchestration operations execution incident system in response to an operations execution incident event and that is generated by a program subsidiary execution incident responsive action predictive model. In this regard, in some embodiments, a predicted program subsidiary execution incident responsive action is a program subsidiary execution incident responsive action generated and/or suggested by a program subsidiary execution incident responsive action predictive model.

As used herein, the term “predicted program subsidiary execution incident responsive action representation” refers to one or more of text, images, or other visual elements that are indicative of a predicted program subsidiary execution incident responsive action. A predicted program subsidiary execution incident responsive action representation is renderable to a visual display, such as an interface component, of a computing device as part of a user interface, or usable to configure and/or fill content of a visual element renderable to a visual display of a computing device as part of a user interface. For example, a predicted program subsidiary execution incident responsive action representation may be renderable to a program orchestration operations configuration incident interface component.

As used herein, the term “program subsidiary execution incident responsive action predictive model” is a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to be used to perform one or more operations described herein, such as to generate a predicted program subsidiary execution incident responsive action. In this regard, in some embodiments, a program subsidiary execution incident responsive action predictive model may be configured to utilize one or more of any type of machine learning, rules-based, and/or artificial intelligence techniques including one or more of computer vision techniques, image processing techniques, optical character recognition techniques, supervised learning (e.g., using user feedback), unsupervised learning, semi-supervised learning, reinforcement learning, sequence modeling techniques, language processing techniques, neural network techniques, and/or generative artificial intelligence techniques. In some embodiments, a program subsidiary execution incident responsive action predictive model is configured to generate a predicted program subsidiary execution incident responsive action based on program operations execution incident data. In this regard, for example, a program subsidiary execution incident responsive action predictive model may be configured to generate and/or suggest program subsidiary execution incident responsive actions that should be included in a program execution incident action set.

As used herein, the term “program orchestration operations configuration incident interface component” refers to a graphical user interface element that is rendered to or as a portion of, a program orchestration operations execution incident interface of a program orchestration operations execution incident system. In some embodiments, a program orchestration operations configuration incident interface component is configured to be used by a user to generate, configure, and/or edit a program execution incident action set. In this regard, in some embodiments, the program orchestration operations configuration incident interface component may be configured to receive program operations execution incident data that may be used to generate a program execution incident action set.

In some embodiments, a program orchestration operations configuration incident interface component may be configured to display a program execution incident action set representation. In this regard, in some embodiments, a program orchestration operations configuration incident interface component may be configured to display one or more of an identifier feature representation, a scope feature representation, a user feature representation, a type feature representation, an operational feature representation, a status feature representation, an execution permission record feature representation, a program execution incident action set representation, and/or the like. Additionally, or alternatively, a program orchestration operations configuration incident interface component is configured to display a predicted program subsidiary execution incident responsive action representation.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

As used herein, the term “computer-readable storage medium” refers to a non-transitory, physical, or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to computer hardware and/or software that is configured to access a service made available by a server (e.g., an operation and escalation management server). The server is often (but not always) on another computer system, in which case the client device accesses the service by way of a network. Client devices may include, without limitation, smart phones, tablet computers, laptop computers, wearables, personal computers, enterprise computers, and the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, the terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked, or remote computing devices, such as, but not limited to, client devices. Non-limiting examples of an application comprise project management, workflow engines, software incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The terms “database,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSqL database (e.g., DynamoDB), and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary”, or “example” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### Example Systems and Apparatuses of the Disclosure

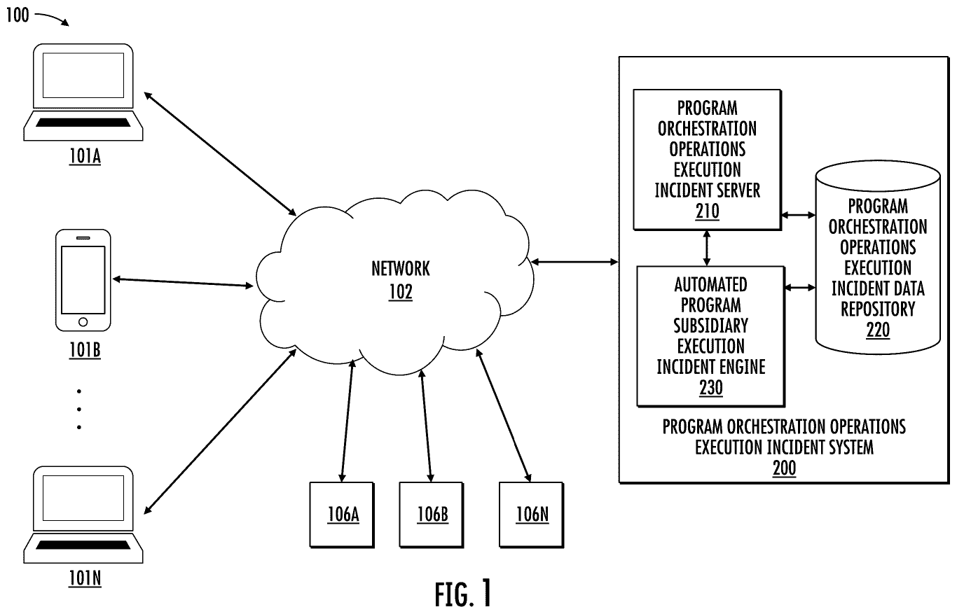

Referring now to FIG. 1, an example computing system 100 architecture within which some embodiments of the present disclosure operate is illustrated. The example computing system 100 comprises one or more software development tools 106A-106N, program orchestration operations execution incident system 200, and a plurality of client devices 101A-101N, each communicatively connected through a communications network 102. Accordingly, user(s) (e.g., team member, individual contributor, team leader, team member, designer, etc.) may access the program orchestration operations execution incident system 200 via the communications network 102 using one or more of client devices 101A-101N. In some embodiments, the example computing system 100 includes one or more program external service nodes 240. In some embodiments, the program orchestration operations execution incident system 200 includes one or more program internal service nodes 250. Program orchestration operations execution incident system 200 may comprise a program orchestration operations execution incident server 210 in communication with at least one repository, such as a program orchestration operations execution data repository 220. Such repository(ies) may be hosted by the program orchestration operations execution incident server 210 or otherwise hosted by devices in communication with the program orchestration operations execution incident server 210.

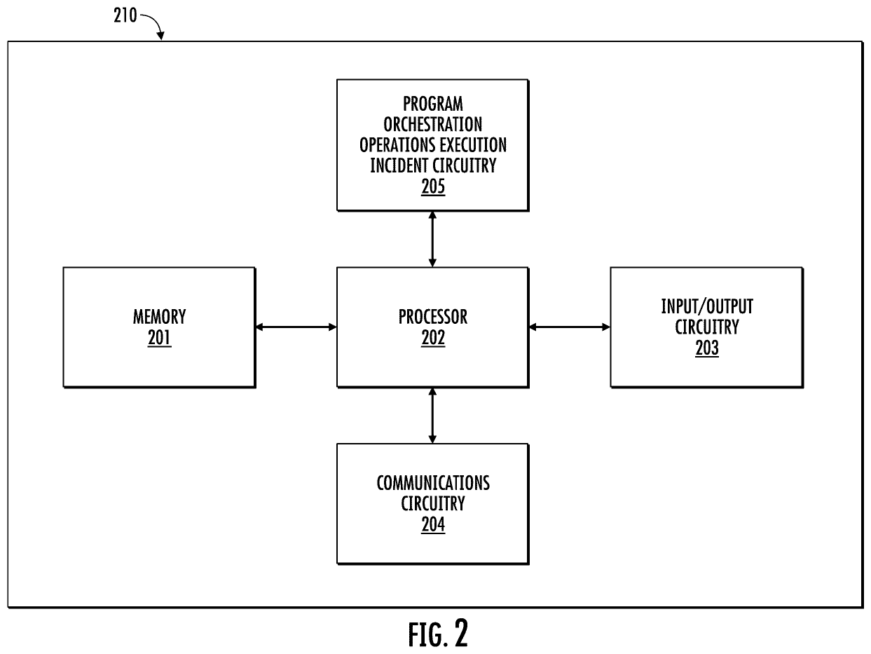

Program orchestration operations execution incident server 210 may include circuitry, networked processors, or the like configured to perform some or all of the program orchestration operations execution incident server-based processes described herein and may be any suitable network server and/or other type of processing device. In some embodiments, program orchestration operations execution incident server 210 may determine and transmit commands and instructions for rendering one or more program orchestration operations execution incident interfaces to client devices 101A-101N, using data from, for example, the program orchestration operations execution data repository 220. In this regard, the program orchestration operations execution incident server 210 may be embodied by any of a variety of devices, for example, the program orchestration operations execution incident server 210 may be embodied as a computer or a plurality of computers. For example, program orchestration operations execution incident server 210 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, program orchestration operations execution incident server 210 may be located remotely from the program orchestration operations execution data repository 220, although in other embodiments, the program orchestration operations execution incident server 210 may comprise the program orchestration operations execution data repository 220. The program orchestration operations execution incident server 210 may, in some embodiments, comprise several servers or computing devices performing interconnected and/or distributed functions. Despite the many arrangements contemplated herein, program orchestration operations execution incident server 210 is shown and described herein as a single computing device to avoid unnecessarily overcomplicating the disclosure.

Program orchestration operations execution incident server 210 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 702.11, IEEE 702.16, IEEE 702.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the program orchestration operations execution incident system 200.

The program orchestration operations execution data repository 220 may be stored by any suitable storage device configured to store some or all of the information described herein (e.g., memory 201 of the program orchestration operations execution incident server 210 or a separate memory system separate from the program orchestration operations execution incident server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. The program orchestration operations execution data repository 220 may comprise data received from the program orchestration operations execution incident server 210 (e.g., via a memory 201 and/or processor(s) 202), and the corresponding storage device may thus store this data. The program orchestration operations execution data repository 220 includes information accessed and stored by the program orchestration operations execution incident server 210 to facilitate the operations of the program orchestration operations execution incident system 200. As such, the program orchestration operations execution data repository 220 may include, for example, without limitation, include unconfigured program orchestration data, program orchestration data, automated program subsidiary execution action engines, program subsidiary execution action input data, program subsidiary orchestration items, program subsidiary execution action executables, aggregated configured program orchestration data, aggregated program subsidiary execution actions, and/or the like.

Software development tools 106A-106N may be any one or more underlying software development tools (e.g., Bitbucket®, etc.).

The client devices 101A-101N may be implemented as any computing device as defined above. Electronic data received by the program orchestration operations execution incident server 210 from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the program orchestration operations execution incident interface to a user and otherwise providing access to the program orchestration operations execution incident system 200. The depiction in FIG. 2 of “N” client devices is merely for illustration purposes. According to some embodiments, the client devices 101A-101N may be configured to display an interface on a display of the client device for viewing, creating, editing, and/or otherwise interacting with at least the program orchestration operations execution incident interface, which may be provided by the program orchestration operations execution incident system 200. According to further embodiments, the client devices 101A-101N may be configured to generate and/or display a program orchestration operations execution incident interface component, a program subsidiary execution incident output interface component, a program orchestration operations repository incident interface component, a program orchestration operations configuration incident interface component, and/or the like.

In embodiments where a client device 101A-101N is a mobile device, such as a smartphone or tablet, the client device 101A-101N may execute an “app” to interact with the program orchestration operations execution incident system 200. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the program orchestration operations execution incident system 200 via a web browser. As yet another example, the client devices 101A-101N may include various hardware or firmware designed to interface with the program orchestration operations execution incident system 200.

### Example Apparatus for Implementing Embodiments of the Present Disclosure

FIG. 2 illustrates an example program orchestration operations execution incident server 210 in accordance with at least some example embodiments of the present disclosure. In accordance with some example embodiments, program orchestration operations execution incident server 210 may include various components, modules, circuitries, or means, some or all of which may be also or instead be included in one or more client device(s) 101A-101N. In accordance with some example embodiments, program orchestration operations execution incident server 210 may be configured, using one or more of the sets of circuitry embodying memory 201, processor 202, input/output circuitry 203, communications circuitry 204, and/or program orchestration operations execution incident circuitry 205 to execute and perform the operations described herein. In some embodiments, program orchestration operations execution incident circuitry 205 is included in program orchestration operations execution incident server 210 and/or client device 101A, the circuitry configured to facilitate the functionality discussed herein regarding generating program orchestration operations execution incident interface components, program subsidiary execution incident output interface components, program orchestration operations repository incident interface components, program orchestration operations configuration incident interface components, and/or the like. In some embodiments, program orchestration operations execution incident circuitry 205 is configured to generate, perform, cause, initiate, execute, and/or implement program subsidiary execution incident responsive actions and/or program execution incident action sets. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201-205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like, to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with program orchestration operations execution incident server 210, other elements of the program orchestration operations execution incident server 210 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, program orchestration operations execution incident server 210. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., program orchestration operations execution incident server 210 to carry out various functions in accordance with example embodiments of the present disclosure.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling the program orchestration operations execution incident server 210 to carry out various functions in accordance with example embodiments discussed herein. For example, in at least some embodiments, memory 201 is configured to buffer data for processing by processor 202. Additionally, or alternatively, in at least some embodiments, memory 201 is configured to store program instructions for execution by processor 202. Memory 201 may store information in the form of static and/or dynamic information. This stored information may be stored and/or used by program orchestration operations execution incident server 210 during the course of performing its functionalities.

Processor 202 may be embodied in a number of different ways and may, for example, include one or more processing devices configured to perform independently. Additionally, or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as program orchestration operations execution incident server 210. The plurality of processors may be in operative communication with each other and may be collectively configured to perform one or more functionalities of program orchestration operations execution incident server 210 as described herein.

In an example embodiment, processor 202 is configured to execute instructions stored in the memory 201 or otherwise accessible to processor 202. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause program orchestration operations execution incident server 210 to perform one or more of the functionalities of program orchestration operations execution incident server 210 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface (e.g., program orchestration operations execution incident interface) and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 in program orchestration operations execution incident server 210 may be reduced when implemented also or instead as an end-user machine or other type of device designed for complex user interactions (i.e., client device 101). In some embodiments (like other components discussed herein), input/output circuitry 203 may even be eliminated from program orchestration operations execution incident server 210. Alternatively, at least some aspects of input/output circuitry 203 may be embodied on an apparatus used by a user (e.g., a team member, an individual contributor, a team leader, and/or the like) that is in communication with program orchestration operations execution incident server 210. Input/output circuitry 203 may be in communication with memory 201, communications circuitry 204, and/or any other component(s), such as via a bus. Although more than one input/output circuitry and/or other component can be included in program orchestration operations execution incident server 210, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with program orchestration operations execution incident server 210. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by program orchestration operations execution incident server 210 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of program orchestration operations execution incident server 210, such as via a bus.

In some embodiments, program orchestration operations execution incident circuitry 205 may also or instead be included and configured to perform the functionality discussed herein related to providing program orchestration operations execution incident interface components, program subsidiary execution incident output interface components, program orchestration operations repository incident interface components, program orchestration operations configuration incident interface components, and/or the like. Program orchestration operations execution incident circuitry 205 includes hardware components and/or software configured to support interface component functionality, features, and/or services of the program orchestration operations execution incident server 210. In some embodiments, program orchestration operations execution incident circuitry 205 includes hardware components and/or software configured to support an automated program subsidiary execution incident engine 230 to generate, perform, cause, initiate, execute, and/or implement program subsidiary execution incident responsive actions, program execution incident action sets, features, and/or services of the program orchestration operations execution incident server 210. The program orchestration operations execution incident circuitry 205 may utilize processing circuitry, such as the processor 202, to perform its corresponding operations, and may utilize memory 201 to store collected information. The program orchestration operations execution incident circuitry 205 may send and/or receive data from the program orchestration operations execution data repository 220. In some implementations, the sent and/or received data may include program operations execution incident data, historical program operations execution incident data, and/or associated data.

It should also be appreciated that, in some embodiments, the program orchestration operations execution incident circuitry 205 may include a separate processor, specially configured field programmable gate array (FPGA), or application specific interface circuit (ASIC) to perform its corresponding functions. For example, in some embodiments, some or all of the functionality of program orchestration operations execution incident circuitry 205 may be performed by processor 202. In this regard, some or all of the example processes and algorithms discussed herein can be performed by at least one processor 202 and/or program orchestration operations execution incident circuitry 205. For example, non-transitory computer readable storage media can be configured to store firmware, one or more application programs, and/or other software, which include instructions and other computer-readable program code portions that can be executed to control processors of the components of program orchestration operations execution incident server 210 to implement various operations, including the examples shown herein. As such, a series of computer-readable program code portions may be embodied in one or more computer program products and can be used, with a device, program orchestration operations execution incident server 210, database, and/or other programmable apparatus, to produce the machine-implemented processes discussed herein. It is also noted that all or some of the information discussed herein can be based on data that is received, generated and/or maintained by one or more components of the program orchestration operations execution incident server 210. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor, or other programmable apparatus's circuitry to produce a machine, such that the computer, processor, or other programmable circuitry that execute the code on the machine creates the means for implementing various functions, including those described herein in connection with the components of program orchestration operations execution incident server 210.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a planning user interacting with the client device). Information/data generated at the client device (e.g., a result of the user interaction) can be received from the client device at the server.

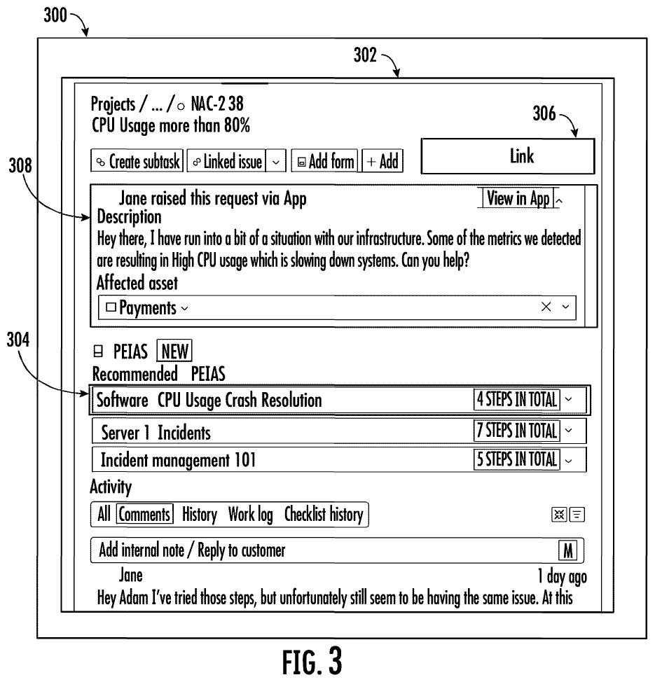

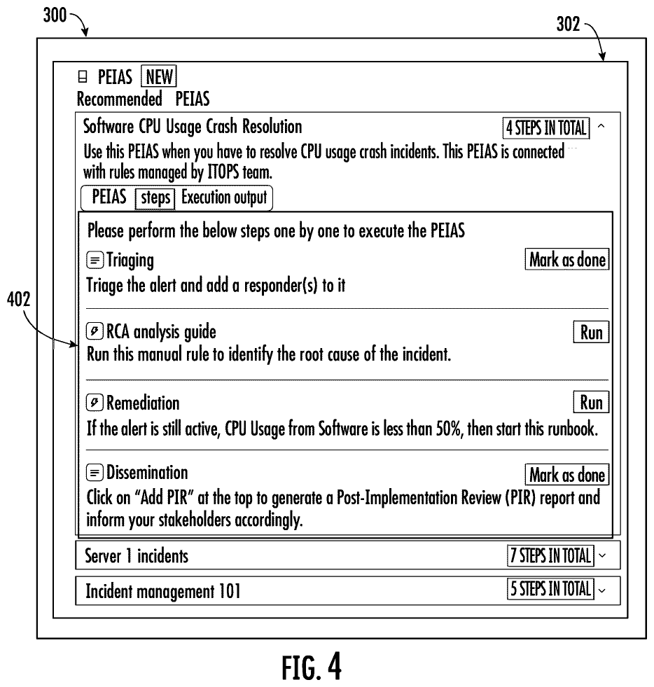

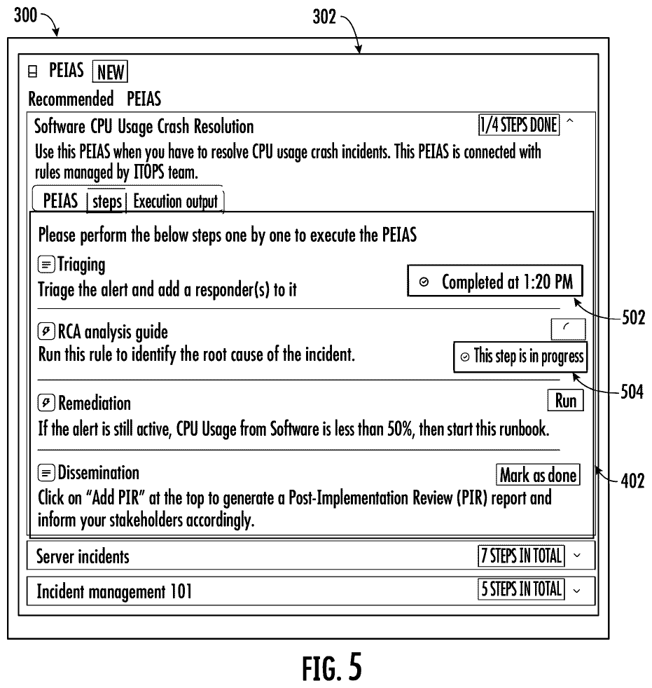

In various embodiments of the present disclosure, an apparatus (e.g., the program orchestration operations execution incident server 210) may be configured to generate, output, manage, and/or cause rendering of a program orchestration operations execution incident interface component of a program orchestration operations execution incident system 200. For example, an apparatus (e.g., the program orchestration operations execution incident server 210) may be configured to output and/or cause rendering of a program orchestration operations execution incident interface component on a program orchestration operations execution incident interface 300 of the program orchestration operations execution incident system 200. FIGS. 3-5 illustrate an example program orchestration operations execution incident interface component 302 structured in accordance with various embodiments of the present disclosure. In some embodiments, the apparatus (e.g., program orchestration operations execution incident server 210) causes rendering of the program orchestration operations execution incident interface component 302 to a visual display of a computing device (e.g., a client device 101A-101N).

In some embodiments, the program orchestration operations execution incident interface component 302 may be configured to display a program execution incident action set representation 304. Additionally, or alternatively, the program orchestration operations execution incident interface component 302 may be configured to display a program execution incident action set link 306. Additionally, or alternatively, the program orchestration operations execution incident interface component 302 may be configured to display an operations execution incident event representation 308.

Additionally, or alternatively, the program orchestration operations execution incident interface component 302 may be configured to display one or more program subsidiary execution incident responsive action representations 402. For example, the program orchestration operations execution incident interface component 302 may be reconfigured to display the one or more program subsidiary execution incident responsive action representations 402 in response to the program orchestration operations execution incident system 200 detecting a program execution incident action set expansion trigger. Additionally, or alternatively, the program orchestration operations execution incident interface component 302 may be configured to display a program subsidiary execution incident output indicator representation 502. For example, the program orchestration operations execution incident interface component 302 may be reconfigured to display the program subsidiary execution incident output indicator representation 502 in response to the program orchestration operations execution incident system 200 identifying a program subsidiary execution incident output. Additionally, or alternatively, the program orchestration operations execution incident interface component 302 may be configured to display a program subsidiary execution incident processing indicator representation 504. For example, the program orchestration operations execution incident interface component 302 may be reconfigured to display the program subsidiary execution incident processing indicator representation 504 in response to the program orchestration operations execution incident system 200 causing execution of a program subsidiary execution incident responsive action.

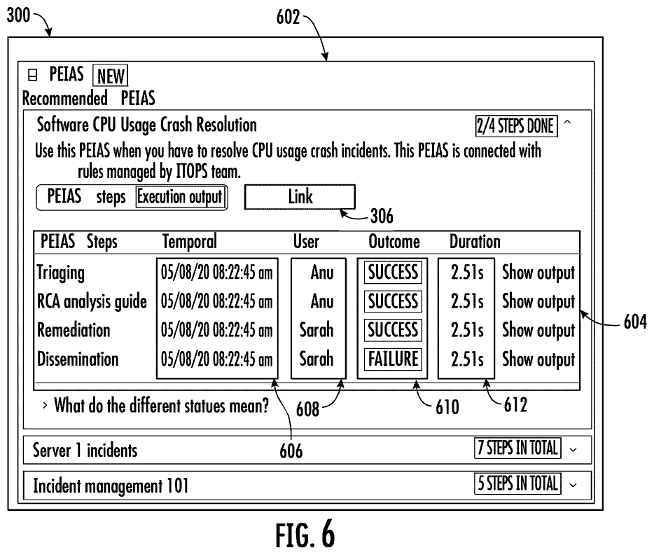

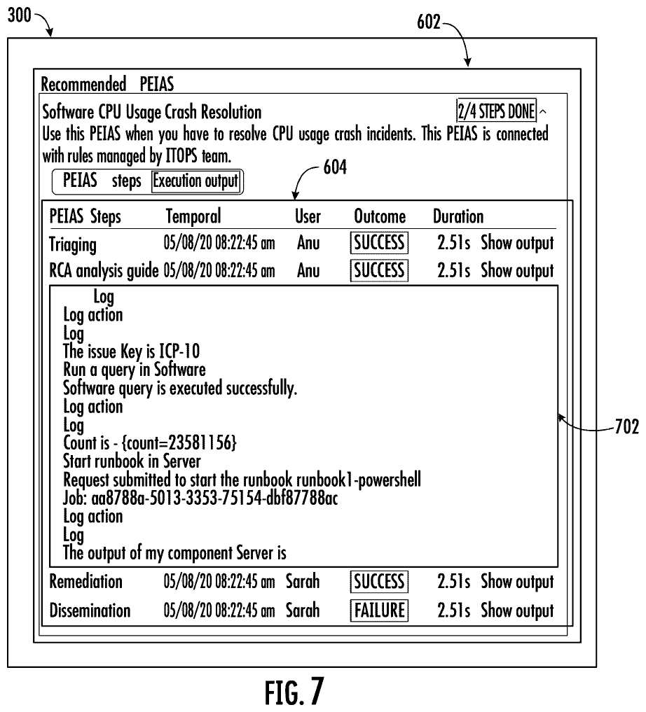

In various embodiments of the present disclosure, an apparatus (e.g., the program orchestration operations execution incident server 210) may be configured to generate, output, manage, and/or cause rendering of a program subsidiary execution incident output interface component of a program orchestration operations execution incident system 200. For example, an apparatus (e.g., the program orchestration operations execution incident server 210) may be configured to output and/or cause rendering of a program subsidiary execution incident output interface component on a program orchestration operations execution incident interface 300 of the program orchestration operations execution incident system 200. FIGS. 6-7 illustrate an example program subsidiary execution incident output interface component 602 structured in accordance with various embodiments of the present disclosure. In some embodiments, the apparatus (e.g., program orchestration operations execution incident server 210) causes rendering of the program subsidiary execution incident output interface component 602 to a visual display of a computing device (e.g., a client device 101A-101N).

In some embodiments, the program subsidiary execution incident output interface component 602 may be configured to display a program subsidiary execution incident output representation 604. In this regard, in some embodiments, the program subsidiary execution incident output interface component 602 may be configured to display one or more of a temporal partial program subsidiary execution incident output representation 606, a user partial program subsidiary execution incident output representation 608, an outcome partial program subsidiary execution incident output representation 610, a duration partial program subsidiary execution incident output representation 612, and/or the like. Additionally, or alternatively, the program subsidiary execution incident output interface component 602 may be configured to display a program subsidiary execution incident output log representation 702. For example, the program subsidiary execution incident output interface component 602 may be reconfigured to display a program subsidiary execution incident output log representation 702 in response to a program orchestration operations execution incident system detecting a program subsidiary execution incident output expansion trigger.

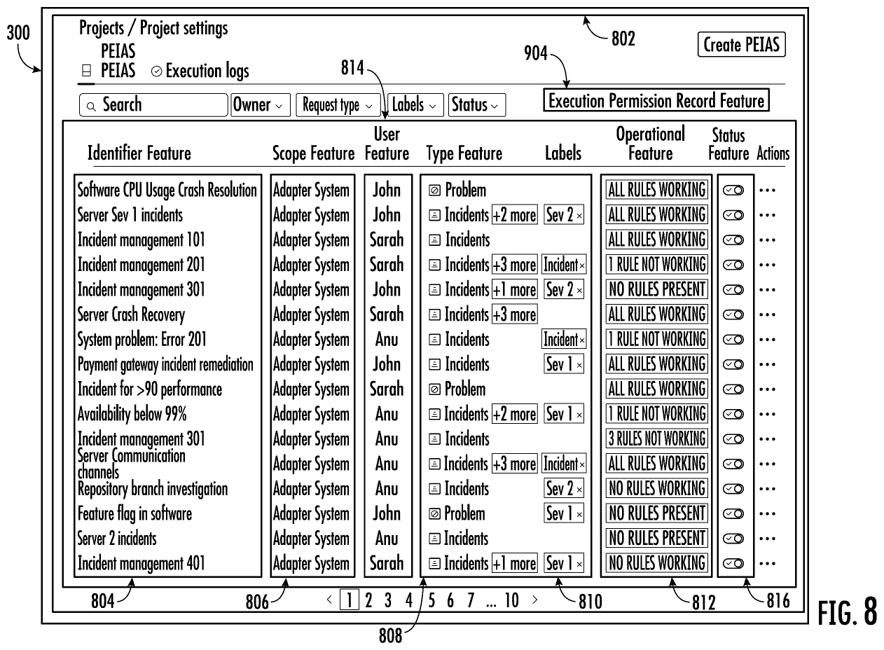

In various embodiments of the present disclosure, an apparatus (e.g., the program orchestration operations execution incident server 210) may be configured to generate, output, manage, and/or cause rendering of a program orchestration operations repository incident interface component of a program orchestration operations execution incident system 200. For example, an apparatus (e.g., the program orchestration operations execution incident server 210) may be configured to output and/or cause rendering of a program orchestration operations repository incident interface component on a program orchestration operations execution incident interface 300 of the program orchestration operations execution incident system 200. FIG. 8 illustrates an example program orchestration operations repository incident interface component 802 structured in accordance with various embodiments of the present disclosure. In some embodiments, the apparatus (e.g., program orchestration operations execution incident server 210) causes rendering of the program orchestration operations repository incident interface component 802 to a visual display of a computing device (e.g., a client device 101A-101N).

In some embodiments, the program orchestration operations repository incident interface component 802 may be configured to display one or more program execution incident action set representations 814. In this regard, in some embodiments, the program orchestration operations repository incident interface component 802 may be configured to display one or more of an identifier feature representation 804, a scope feature representation 806, a user feature representation 808, a type feature representation 810, an operational feature representation 812, a status feature representation 816, an execution permission record feature representation 904, and/or the like.

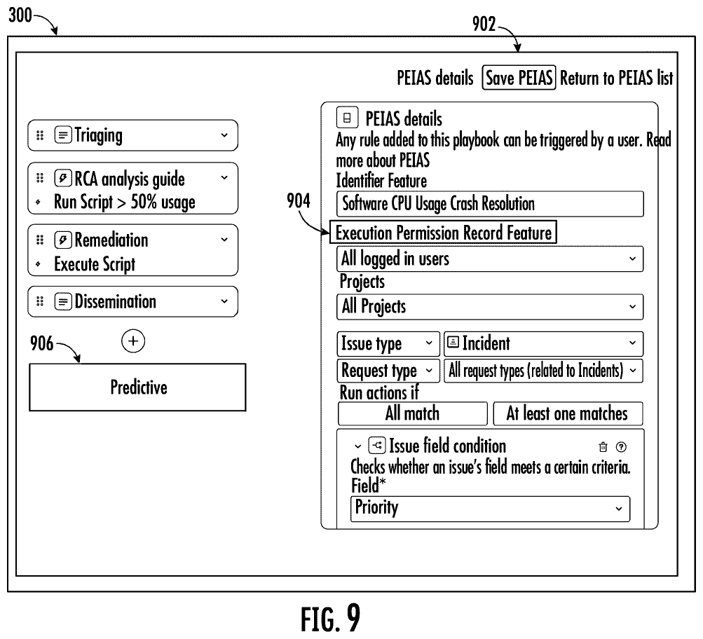

In various embodiments of the present disclosure, an apparatus (e.g., the program orchestration operations execution incident server 210) may be configured to generate, output, manage, and/or cause rendering of a program orchestration operations configuration incident interface component of a program orchestration operations execution incident system 200. For example, an apparatus (e.g., the program orchestration operations execution incident server 210) may be configured to output and/or cause rendering of a program orchestration operations configuration incident interface component on a program orchestration operations execution incident interface 300 of the program orchestration operations execution incident system 200. FIG. 9 illustrates an example program orchestration operations configuration incident interface component 902 structured in accordance with various embodiments of the present disclosure. In some embodiments, the apparatus (e.g., program orchestration operations execution incident server 210) causes rendering of the program orchestration operations configuration incident interface component 902 to a visual display of a computing device (e.g., a client device 101A-101N).

In some embodiments, the program orchestration operations configuration incident interface component 902 is configured to be used by a user to generate, configure, and/or edit a program execution incident action set. In this regard, in some embodiments, the program orchestration operations configuration incident interface component may be configured to receive program operations execution incident data that may be used to generate a program execution incident action set.

In some embodiments, the program orchestration operations configuration incident interface component 902 may be configured to display a program execution incident action set representation. In this regard, in some embodiments, the program orchestration operations configuration incident interface component 902 may be configured to display one or more of an identifier feature representation 804, a scope feature representation 806, a user feature representation 808, a type feature representation 810, an operational feature representation 812, a status feature representation 816, an execution permission record feature representation 904, and/or the like. Additionally, or alternatively, the program orchestration operations configuration incident interface component 902 is configured to display a predicted program subsidiary execution incident responsive action representation 906.

### Example Operations Performed

Having described example systems and apparatuses and exemplary circuitry in accordance with various embodiments of the present disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. It will further be appreciated that the example apparatuses, systems, devices, and/or computer program products may proceed to output and/or provide program orchestration operations execution incident interface components, program subsidiary execution incident output interface components, program orchestration operations repository incident interface components, program orchestration operations configuration incident interface components, and/or the like in a program orchestration operations execution incident system 200 in a number of ways. Additionally, or alternatively, it will further be appreciated that the example apparatuses, systems, devices, and/or computer program products may proceed to generate, cause, and/or initiate, for example using an automated program subsidiary execution incident engine 230, execution of execution of one or more program subsidiary execution incident responsive actions and/or the like in a program orchestration operations execution incident system 200 in a number of ways.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

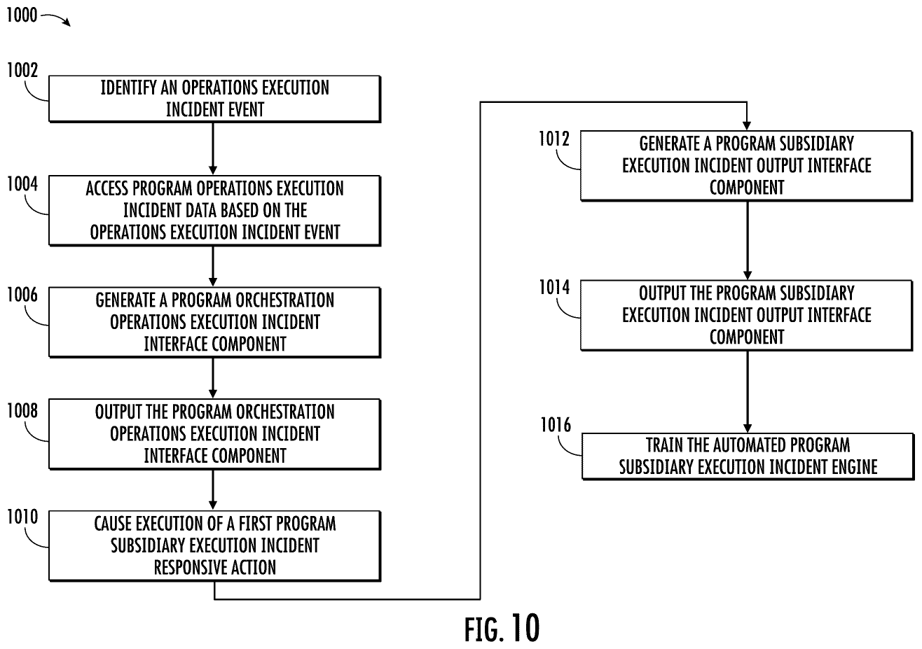

FIG. 10 is a flowchart broadly illustrating a series of operations or process blocks that are executed or performed to output a program subsidiary execution incident output interface component for rendering to the program orchestration operations execution incident interface in accordance with some example embodiments of the present disclosure. In some embodiments, the method 1000 is embodied by computer program code stored on a non-transitory computer-readable storage medium of a computer program product configured for execution to perform the process as depicted and described. In this regard, in some such embodiments, the program orchestration operations execution incident server 210 is specially configured by computer-coded instructions (e.g., computer program instructions) stored thereon, for example in the memory 201 and/or another component depicted and/or described herein and/or otherwise accessible to the program orchestration operations execution incident server 210, for performing the operations as depicted and described. Alternatively, or additionally, in some embodiments, the method 1000 is performed by one or more specially configured computing devices, such as the program orchestration operations execution incident server 210 alone or in communication with one or more other component(s), device(s), system(s), and/or the like. For example, in some embodiments, the program orchestration operations execution incident server 210 is in communication with one or more external apparatus(es), system(s), device(s), and/or the like, to perform one or more of the operations as depicted and described. For purposes of simplifying the description, the method 1000 is described as performed by and from the perspective of the program orchestration operations execution incident server 210. In this regard, performance of the operations may invoke one or more of memory 201, processor 202, input/output circuitry 203, communications circuitry 204, and/or program orchestration operations execution incident circuitry 205.

In the embodiment illustrated in FIG. 10, the flowchart illustrates method 1000 which begins at block 1002. At block 1002, the program orchestration operations execution incident server 210 includes means, such as the memory 201, processor 202, input/output circuitry 203, communications circuitry 204, and/or program orchestration operations execution incident circuitry 205, or a combination thereof, to identify an operations execution incident event. In some embodiments, the operations execution incident event is one or more of a computer processing unit execution rate event, a computing server execution error event, a computing network node error event, a software application execution error event, or a communication channel error event.

At block 1004, the program orchestration operations execution incident server 210 includes means, such as the memory 201, processor 202, input/output circuitry 203, communications circuitry 204, and/or program orchestration operations execution incident circuitry 205, or a combination thereof, to access program operations execution incident data based on the operations execution incident event. In some embodiments, the program operations execution incident data is representative of a program execution incident action set. In some embodiments, the program execution incident action set comprises one or more program subsidiary execution incident responsive actions.

At block 1006, the program orchestration operations execution incident server 210 includes means, such as the memory 201, processor 202, input/output circuitry 203, communications circuitry 204, and/or program orchestration operations execution incident circuitry 205, or a combination thereof, to generate a program orchestration operations execution incident interface component. In some embodiments, the program orchestration operations execution incident interface component is generated based on the operations execution incident event and program operations execution incident data. In some embodiments, the program orchestration operations execution incident interface component comprises a program execution incident action set representation. In some embodiments, the program orchestration operations execution incident interface component comprises a program execution incident action set link. In some embodiments, a program orchestration operations repository incident interface component is outputted for rendering to the program orchestration operations execution incident interface or a program orchestration operations configuration incident interface component is outputted for rendering to the program orchestration operations execution incident interface in response to receiving a selection of the program execution incident action set link. In some embodiments, the program orchestration operations execution incident interface component comprises an operations execution incident event representation.

At block 1008, the program orchestration operations execution incident server 210 includes means, such as the memory 201, processor 202, input/output circuitry 203, communications circuitry 204, and/or program orchestration operations execution incident circuitry 205, or a combination thereof, to output the program orchestration operations execution incident interface component. In some embodiments, the program orchestration operations execution incident interface component is outputted for rendering to a program orchestration operations execution incident interface.

At block 1010, the program orchestration operations execution incident server 210 includes means, such as the memory 201, processor 202, input/output circuitry 203, communications circuitry 204, and/or program orchestration operations execution incident circuitry 205, or a combination thereof, to cause execution of a first program subsidiary execution incident responsive action. In some embodiments, the first program subsidiary execution incident responsive action is caused to execute using an automated program subsidiary execution incident engine. In some embodiments, the first program subsidiary execution incident responsive action is one of one or more program subsidiary execution incident responsive actions. In some embodiments, automated program subsidiary execution incident engine is configured to execute the one or more program subsidiary execution incident responsive actions in accordance with at least one of a sequential program subsidiary execution incident responsive action execution operation, a temporal program subsidiary execution incident responsive action execution operation, an event program subsidiary execution incident responsive action execution operation, or a parallel program subsidiary execution incident responsive action execution operation.

At block 1012, the program orchestration operations execution incident server 210 includes means, such as the memory 201, processor 202, input/output circuitry 203, communications circuitry 204, and/or program orchestration operations execution incident circuitry 205, or a combination thereof, to a program subsidiary execution incident output interface component. In some embodiments, the program subsidiary execution incident output interface component comprises a program subsidiary execution incident output representation associated with the first program subsidiary execution incident responsive action. In some embodiments, the program subsidiary execution incident output representation is indicative of a program subsidiary execution incident output.

At block 1014, the program orchestration operations execution incident server 210 includes means, such as the memory 201, processor 202, input/output circuitry 203, communications circuitry 204, and/or program orchestration operations execution incident circuitry 205, or a combination thereof, to output the program subsidiary execution incident output interface component. In some embodiments, the program subsidiary execution incident output interface component is outputted for rendering to a program orchestration operations execution incident interface.

At block 1016, the program orchestration operations execution incident server 210 includes means, such as the memory 201, processor 202, input/output circuitry 203, communications circuitry 204, and/or program orchestration operations execution incident circuitry 205, or a combination thereof, to train the automated program subsidiary execution incident engine. In some embodiments, the automated program subsidiary execution incident engine is trained based at least in part on historical program operations execution incident data or historical program subsidiary execution incident output.

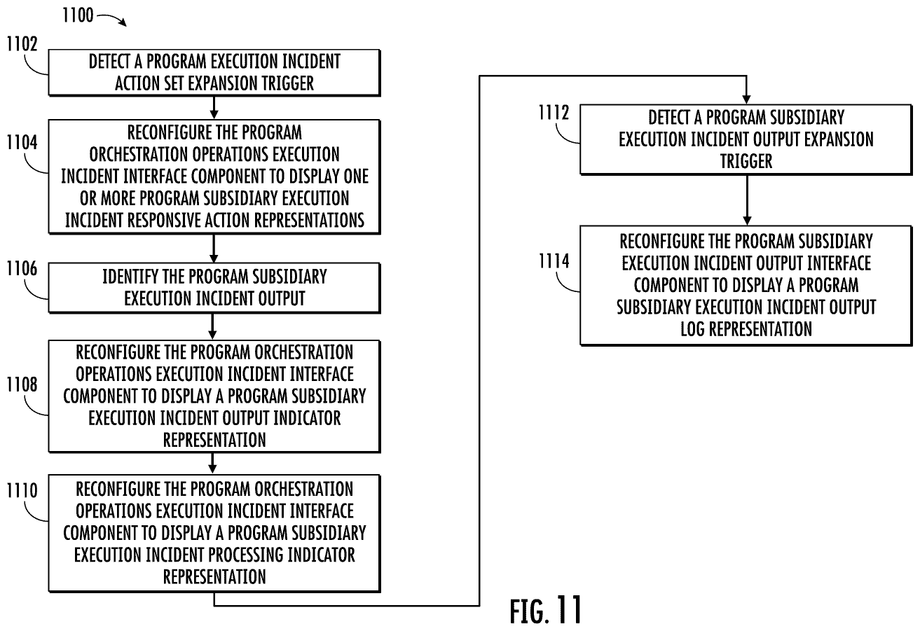

FIG. 11 is a flowchart broadly illustrating a series of operations or process blocks that are executed or performed to reconfigure various interface components in accordance with some example embodiments of the present disclosure. In some embodiments, the method 1100 is embodied by computer program code stored on a non-transitory computer-readable storage medium of a computer program product configured for execution to perform the process as depicted and described. In this regard, in some such embodiments, the program orchestration operations execution incident server 210 is specially configured by computer-coded instructions (e.g., computer program instructions) stored thereon, for example in the memory 201 and/or another component depicted and/or described herein and/or otherwise accessible to the program orchestration operations execution incident server 210, for performing the operations as depicted and described. Alternatively, or additionally, in some embodiments, the method 1100 is performed by one or more specially configured computing devices, such as the program orchestration operations execution incident server 210 alone or in communication with one or more other component(s), device(s), system(s), and/or the like. For example, in some embodiments, the program orchestration operations execution incident server 210 is in communication with one or more external apparatus(es), system(s), device(s), and/or the like, to perform one or more of the operations as depicted and described. For purposes of simplifying the description, the method 1100 is described as performed by and from the perspective of the program orchestration operations execution incident server 210. In this regard, performance of the operations may invoke one or more of memory 201, processor 202, input/output circuitry 203, communications circuitry 204, and/or program orchestration operations execution incident circuitry 205.

In the embodiment illustrated in FIG. 11, the flowchart illustrates method 1100 which begins at block 1102. At block 1102, the program orchestration operations execution incident server 210 includes means, such as the memory 201, processor 202, input/output circuitry 203, communications circuitry 204, and/or program orchestration operations execution incident circuitry 205, or a combination thereof, to detect a program execution incident action set expansion trigger.

At block 1104, the program orchestration operations execution incident server 210 includes means, such as the memory 201, processor 202, input/output circuitry 203, communications circuitry 204, and/or program orchestration operations execution incident circuitry 205, or a combination thereof, to reconfigure the program orchestration operations execution incident interface component to display one or more program subsidiary execution incident responsive action representations. In some embodiments, the program orchestration operations execution incident interface component is reconfigured in response to detecting the program execution incident action set expansion trigger.

At block 1106, the program orchestration operations execution incident server 210 includes means, such as the memory 201, processor 202, input/output circuitry 203, communications circuitry 204, and/or program orchestration operations execution incident circuitry 205, or a combination thereof, to detecting the program execution incident action set expansion trigger.

At block 1108, the program orchestration operations execution incident server 210 includes means, such as the memory 201, processor 202, input/output circuitry 203, communications circuitry 204, and/or program orchestration operations execution incident circuitry 205, or a combination thereof, to reconfigure the program orchestration operations execution incident interface component to display a program subsidiary execution incident output indicator representation. In some embodiments, the program orchestration operations execution incident interface component is reconfigured in response to identifying the program subsidiary execution incident output.

At block 1110, the program orchestration operations execution incident server 210 includes means, such as the memory 201, processor 202, input/output circuitry 203, communications circuitry 204, and/or program orchestration operations execution incident circuitry 205, or a combination thereof, to reconfigure the program orchestration operations execution incident interface component to display a program subsidiary execution incident processing indicator representation. In some embodiments, the program orchestration operations execution incident interface component is reconfigured in response to causing execution of the first program subsidiary execution incident responsive action.

At block 1112, the program orchestration operations execution incident server 210 includes means, such as the memory 201, processor 202, input/output circuitry 203, communications circuitry 204, and/or program orchestration operations execution incident circuitry 205, or a combination thereof, to detect a program subsidiary execution incident output expansion trigger.

At block 1114, the program orchestration operations execution incident server 210 includes means, such as the memory 201, processor 202, input/output circuitry 203, communications circuitry 204, and/or program orchestration operations execution incident circuitry 205, or a combination thereof, to reconfigure the program subsidiary execution incident output interface component to display a program subsidiary execution incident output log representation. In some embodiments, the program subsidiary execution incident output interface component is reconfigured in response to detecting the program subsidiary execution incident output expansion trigger.

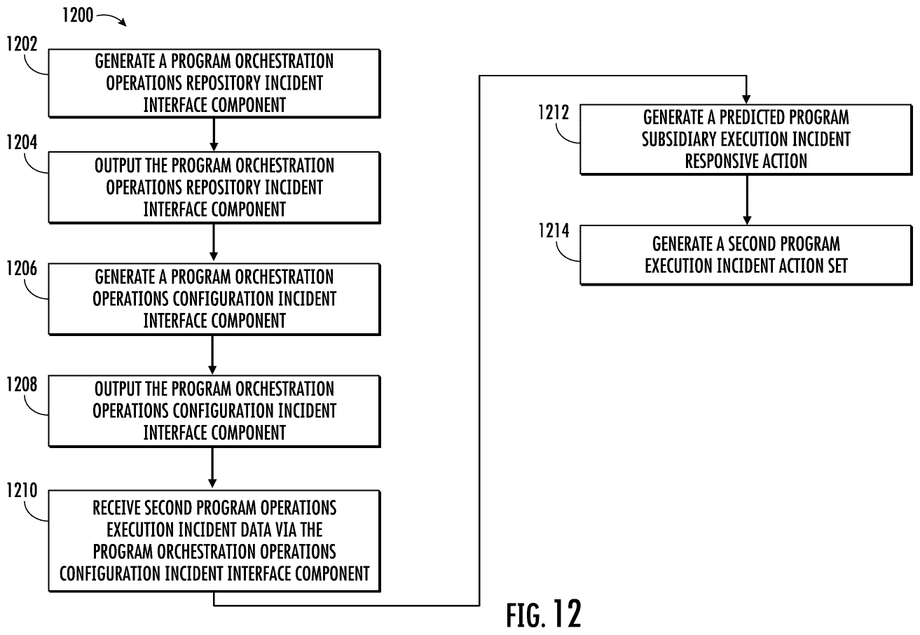

FIG. 12 is a flowchart broadly illustrating a series of operations or process blocks that are executed or performed to generate various interface components in accordance with some example embodiments of the present disclosure. In some embodiments, the method 1200 is embodied by computer program code stored on a non-transitory computer-readable storage medium of a computer program product configured for execution to perform the process as depicted and described. In this regard, in some such embodiments, the program orchestration operations execution incident server 210 is specially configured by computer-coded instructions (e.g., computer program instructions) stored thereon, for example in the memory 201 and/or another component depicted and/or described herein and/or otherwise accessible to the program orchestration operations execution incident server 210, for performing the operations as depicted and described. Alternatively, or additionally, in some embodiments, the method 1200 is performed by one or more specially configured computing devices, such as the program orchestration operations execution incident server 210 alone or in communication with one or more other component(s), device(s), system(s), and/or the like. For example, in some embodiments, the program orchestration operations execution incident server 210 is in communication with one or more external apparatus(es), system(s), device(s), and/or the like, to perform one or more of the operations as depicted and described. For purposes of simplifying the description, the method 1200 is described as performed by and from the perspective of the program orchestration operations execution incident server 210. In this regard, performance of the operations may invoke one or more of memory 201, processor 202, input/output circuitry 203, communications circuitry 204, and/or program orchestration operations execution incident circuitry 205.

In the embodiment illustrated in FIG. 12, the flowchart illustrates method 1200 which begins at block 1202. At block 1202, the program orchestration operations execution incident server 210 includes means, such as the memory 201, processor 202, input/output circuitry 203, communications circuitry 204, and/or program orchestration operations execution incident circuitry 205, or a combination thereof, to generate a program orchestration operations repository incident interface component. In some embodiments, the program orchestration operations repository incident interface component is generated based on the program operations execution incident data. In some embodiments, the program orchestration operations execution incident interface component comprises a plurality of program execution incident action set representations.

At block 1204, the program orchestration operations execution incident server 210 includes means, such as the memory 201, processor 202, input/output circuitry 203, communications circuitry 204, and/or program orchestration operations execution incident circuitry 205, or a combination thereof, to output the program orchestration operations repository incident interface component. In some embodiments, the program orchestration operations repository incident interface component is outputted for rendering to the program orchestration operations execution incident interface.

At block 1206, the program orchestration operations execution incident server 210 includes means, such as the memory 201, processor 202, input/output circuitry 203, communications circuitry 204, and/or program orchestration operations execution incident circuitry 205, or a combination thereof, to generate a program orchestration operations configuration incident interface component.

At block 1208, the program orchestration operations execution incident server 210 includes means, such as the memory 201, processor 202, input/output circuitry 203, communications circuitry 204, and/or program orchestration operations execution incident circuitry 205, or a combination thereof, to output the program orchestration operations configuration incident interface component. In some embodiments, the program orchestration operations configuration incident interface component is outputted for rendering to the program orchestration operations execution incident interface.

At block 1210, the program orchestration operations execution incident server 210 includes means, such as the memory 201, processor 202, input/output circuitry 203, communications circuitry 204, and/or program orchestration operations execution incident circuitry 205, or a combination thereof, to receive second program operations execution incident data via the program orchestration operations configuration incident interface component

At block 1212, the program orchestration operations execution incident server 210 includes means, such as the memory 201, processor 202, input/output circuitry 203, communications circuitry 204, and/or program orchestration operations execution incident circuitry 205, or a combination thereof, to generate a predicted program subsidiary execution incident responsive action. In some embodiments, the predicted program subsidiary execution incident responsive action is generated based at least in part on applying the second program operations execution incident data to a program subsidiary execution incident responsive action predictive model.

At block 1214, the program orchestration operations execution incident server 210 includes means, such as the memory 201, processor 202, input/output circuitry 203, communications circuitry 204, and/or program orchestration operations execution incident circuitry 205, or a combination thereof, to generate a second program execution incident action set. In some embodiments, the second program execution incident action set comprises the predicted program subsidiary execution incident responsive action.

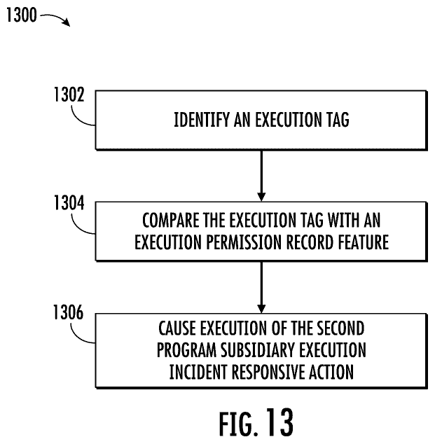

FIG. 13 is a flowchart broadly illustrating a series of operations or process blocks that are executed or performed to cause execution of a second program subsidiary execution incident responsive action in accordance with some example embodiments of the present disclosure. In some embodiments, the method 1300 is embodied by computer program code stored on a non-transitory computer-readable storage medium of a computer program product configured for execution to perform the process as depicted and described. In this regard, in some such embodiments, the program orchestration operations execution incident server 210 is specially configured by computer-coded instructions (e.g., computer program instructions) stored thereon, for example in the memory 201 and/or another component depicted and/or described herein and/or otherwise accessible to the program orchestration operations execution incident server 210, for performing the operations as depicted and described. Alternatively, or additionally, in some embodiments, the method 1300 is performed by one or more specially configured computing devices, such as the program orchestration operations execution incident server 210 alone or in communication with one or more other component(s), device(s), system(s), and/or the like. For example, in some embodiments, the program orchestration operations execution incident server 210 is in communication with one or more external apparatus(es), system(s), device(s), and/or the like, to perform one or more of the operations as depicted and described. For purposes of simplifying the description, the method 1300 is described as performed by and from the perspective of the program orchestration operations execution incident server 210. In this regard, performance of the operations may invoke one or more of memory 201, processor 202, input/output circuitry 203, communications circuitry 204, and/or program orchestration operations execution incident circuitry 205.

In the embodiment illustrated in FIG. 13, the flowchart illustrates method 1300 which begins at block 1302. At block 1302, the program orchestration operations execution incident server 210 includes means, such as the memory 201, processor 202, input/output circuitry 203, communications circuitry 204, and/or program orchestration operations execution incident circuitry 205, or a combination thereof, to identify an execution tag associated with the second program subsidiary execution incident responsive action.

At block 1304, the program orchestration operations execution incident server 210 includes means, such as the memory 201, processor 202, input/output circuitry 203, communications circuitry 204, and/or program orchestration operations execution incident circuitry 205, or a combination thereof, to compare the execution tag with an execution permission record feature associated with the second program subsidiary execution incident responsive action.

At block 1306, the program orchestration operations execution incident server 210 includes means, such as the memory 201, processor 202, input/output circuitry 203, communications circuitry 204, and/or program orchestration operations execution incident circuitry 205, or a combination thereof, to cause, using an automated program subsidiary execution incident engine, execution of the second program subsidiary execution incident responsive action.

FIGS. 10, 11, 12, and 13 thus illustrate flowcharts describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 201 of the program orchestration operations execution incident server 210 and executed by a processor 202 of the program orchestration operations execution incident server 210. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of the present disclosure or of what may be claimed, but rather as description of features specific to particular embodiments of the present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Conclusion

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for outputting a program subsidiary execution incident output interface component for rendering to a program orchestration operations execution incident interface, the apparatus comprising at least one processor, and at least one memory including program code, the at least one memory and the program code configured to, with the at least one processor, cause the apparatus to at least:
identify an operations execution incident event;
access program operations execution incident data based on the operations execution incident event, wherein the program operations execution incident data is representative of a program execution incident action set, wherein the program execution incident action set comprises one or more program subsidiary execution incident responsive actions;
generate a program orchestration operations execution incident interface component based on the operations execution incident event and program operations execution incident data, wherein the program orchestration operations execution incident interface component comprises a program execution incident action set representation;
output the program orchestration operations execution incident interface component for rendering to a program orchestration operations execution incident interface;
cause, using an automated program subsidiary execution incident engine, execution of a first program subsidiary execution incident responsive action of the one or more program subsidiary execution incident responsive actions;
generate a program subsidiary execution incident output interface component, wherein the program subsidiary execution incident output interface component comprises a program subsidiary execution incident output representation associated with the first program subsidiary execution incident responsive action, wherein the program subsidiary execution incident output representation is indicative of a program subsidiary execution incident output; and
output the program subsidiary execution incident output interface component for rendering to the program orchestration operations execution incident interface.

2. The apparatus of claim 1, wherein the program code is further configured to, with the at least one processor, cause the apparatus to:
detect a program execution incident action set expansion trigger; and
in response to detecting the program execution incident action set expansion trigger, reconfigure the program orchestration operations execution incident interface component to display one or more program subsidiary execution incident responsive action representations.

3. The apparatus of claim 1, wherein the program code is further configured to, with the at least one processor, cause the apparatus to:
identify the program subsidiary execution incident output; and
in response to identifying the program subsidiary execution incident output, reconfigure the program orchestration operations execution incident interface component to display a program subsidiary execution incident output indicator representation.

4. The apparatus of claim 1, wherein the program code is further configured to, with the at least one processor, cause the apparatus to:
in response to causing execution of the first program subsidiary execution incident responsive action, reconfigure the program orchestration operations execution incident interface component to display a program subsidiary execution incident processing indicator representation.

5. The apparatus of claim 1, wherein the program code is further configured to, with the at least one processor, cause the apparatus to:
detect a program subsidiary execution incident output expansion trigger; and
in response to detecting the program subsidiary execution incident output expansion trigger, reconfigure the program subsidiary execution incident output interface component to display a program subsidiary execution incident output log representation.

6. The apparatus of claim 1, wherein the program code is further configured to, with the at least one processor, cause the apparatus to:
generate a program orchestration operations repository incident interface component based on the program operations execution incident data, wherein the program orchestration operations execution incident interface component comprises a plurality of program execution incident action set representations; and
output the program orchestration operations repository incident interface component for rendering to the program orchestration operations execution incident interface.

7. The apparatus of claim 1, wherein the program code is further configured to, with the at least one processor, cause the apparatus to:
generate a program orchestration operations configuration incident interface component;
output the program orchestration operations configuration incident interface component for rendering to the program orchestration operations execution incident interface; and
receive second program operations execution incident data via the program orchestration operations configuration incident interface component.

8. The apparatus of claim 7, wherein the program code is further configured to, with the at least one processor, cause the apparatus to:
generate, based at least in part on applying the second program operations execution incident data to a program subsidiary execution incident responsive action predictive model, a predicted program subsidiary execution incident responsive action; and
generate a second program execution incident action set, wherein the second program execution incident action set comprises the predicted program subsidiary execution incident responsive action.

9. The apparatus of claim 1, wherein the program orchestration operations execution incident interface component comprises a program execution incident action set link, wherein the program code is further configured to, with the at least one processor, cause the apparatus to output a program orchestration operations repository incident interface component for rendering to the program orchestration operations execution incident interface or a program orchestration operations configuration incident interface component for rendering to the program orchestration operations execution incident interface in response to receiving a selection of the program execution incident action set link.

10. The apparatus of claim 1, wherein the automated program subsidiary execution incident engine is configured to execute the one or more program subsidiary execution incident responsive actions in accordance with at least one of a sequential program subsidiary execution incident responsive action execution operation, a temporal program subsidiary execution incident responsive action execution operation, an event program subsidiary execution incident responsive action execution operation, or a parallel program subsidiary execution incident responsive action execution operation.

11. The apparatus of claim 1, wherein the program code is further configured to, with the at least one processor, cause the apparatus to:
train the automated program subsidiary execution incident engine based at least in part on historical program operations execution incident data or historical program subsidiary execution incident output.

12. The apparatus of claim 1, wherein the program orchestration operations execution incident interface component comprises an operations execution incident event representation.

13. The apparatus of claim 1, wherein the operations execution incident event is one or more of a computer processing unit execution rate event, a computing server execution error event, a computing network node error event, a software application execution error event, or a communication channel error event.

14. The apparatus of claim 1, wherein the program code is further configured to, with the at least one processor, cause the apparatus to:
cause, using the automated program subsidiary execution incident engine, execution of a second program subsidiary execution incident responsive action of the one or more program subsidiary execution incident responsive actions, wherein causing execution of the second program subsidiary execution incident responsive action comprises the program code being further configured to, with the at least one processor, cause the apparatus to:
identify an execution tag associated with the second program subsidiary execution incident responsive action;
compare the execution tag with an execution permission record feature associated with the second program subsidiary execution incident responsive action; and
cause, using an automated program subsidiary execution incident engine, execution of the second program subsidiary execution incident responsive action.

15. A method for outputting a program subsidiary execution incident output interface component for rendering to a program orchestration operations execution incident interface, the method comprising:
identifying an operations execution incident event;
accessing program operations execution incident data based on the operations execution incident event, wherein the program operations execution incident data is representative of a program execution incident action set, wherein the program execution incident action set comprises one or more program subsidiary execution incident responsive actions;
generating a program orchestration operations execution incident interface component based on the operations execution incident event and program operations execution incident data, wherein the program orchestration operations execution incident interface component comprises a program execution incident action set representation, wherein the program orchestration operations execution incident interface component comprises an operations execution incident event representation;
outputting the program orchestration operations execution incident interface component for rendering to a program orchestration operations execution incident interface;
causing, using an automated program subsidiary execution incident engine, execution of a first program subsidiary execution incident responsive action of the one or more program subsidiary execution incident responsive actions;
generating a program subsidiary execution incident output interface component, wherein the program subsidiary execution incident output interface component comprises a program subsidiary execution incident output representation associated with the first program subsidiary execution incident responsive action, wherein the program subsidiary execution incident output representation is indicative of a program subsidiary execution incident output; and
outputting the program subsidiary execution incident output interface component for rendering to the program orchestration operations execution incident interface.

16. The method of claim 15, further comprising:
detecting a program execution incident action set expansion trigger; and
in response to detecting the program execution incident action set expansion trigger, reconfiguring the program orchestration operations execution incident interface component to display one or more program subsidiary execution incident responsive action representations.

17. The method of claim 15, further comprising:
identifying the program subsidiary execution incident output; and
in response to identifying the program subsidiary execution incident output, reconfiguring the program orchestration operations execution incident interface component to display a program subsidiary execution incident output indicator representation.

18. The method of claim 15, further comprising:
in response to causing execution of the first program subsidiary execution incident responsive action, reconfiguring the program orchestration operations execution incident interface component to display a program subsidiary execution incident processing indicator representation.

19. The method of claim 15, further comprising:
detecting a program subsidiary execution incident output expansion trigger; and
in response to detecting the program subsidiary execution incident output expansion trigger, reconfiguring the program subsidiary execution incident output interface component to display a program subsidiary execution incident output log representation.

20. A computer program product for outputting a program subsidiary execution incident output interface component for rendering to a program orchestration operations execution incident interface, the computer program product comprising at least one non-transitory computer-readable storage medium having computer-readable program code portions stored therein, the computer-readable program code portions comprising an executable portion configured to:
identify an operations execution incident event;
access program operations execution incident data based on the operations execution incident event, wherein the program operations execution incident data is representative of a program execution incident action set, wherein the program execution incident action set comprises one or more program subsidiary execution incident responsive actions;
generate a program orchestration operations execution incident interface component based on the operations execution incident event and program operations execution incident data, wherein the program orchestration operations execution incident interface component comprises a program execution incident action set representation, wherein the program orchestration operations execution incident interface component comprises a program execution incident action set link;
output the program orchestration operations execution incident interface component for rendering to a program orchestration operations execution incident interface;
cause, using an automated program subsidiary execution incident engine, execution of a first program subsidiary execution incident responsive action of the one or more program subsidiary execution incident responsive actions;
generate a program subsidiary execution incident output interface component, wherein the program subsidiary execution incident output interface component comprises a program subsidiary execution incident output representation associated with the first program subsidiary execution incident responsive action, wherein the program subsidiary execution incident output representation is indicative of a program subsidiary execution incident output; and
output the program subsidiary execution incident output interface component for rendering to the program orchestration operations execution incident interface.
